(19) United States
(12) Patent Application Publication
(10) Pub. No.: US 2021/0307395 A1
(43) Pub. Date: Oct. 7, 2021

(54) Device for Vaporization of Concentrated Phyto Material Extracts

(71) Applicant: GS Holistic, LLC, Los Angeles, CA (US)

(72) Inventor: Michael Trzecieski, Parry Sound (CA)

(21) Appl. No.: 17/200,786

(22) Filed: Mar. 13, 2021

Related U.S. Application Data
(63) Continuation-in-part of application No. 17/194,214, filed on Mar. 6, 2021.
Application No. 17/194,214 is a continuation-in-part of application No. 16/711,569, filed on Dec. 12, 2019.
Application No. 16/711,569 is a continuation-in-part of application No. 15/240,203, filed on Aug. 18, 2016, now Pat. No. 10,537,690.
(60) Provisional application No. 62/989,387, filed on Mar. 13, 2020.
(60) Provisional application No. 62/986,701, filed on Mar. 8, 2020.
(60) Provisional application No. 62/215,168, filed on Sep. 8, 2015.

(51) Int. Cl. A24F 40/46; A24F 40/10; A24F 40/44; A24F 1/30; A24F 40/485; A24F 40/57; H05B 3/44

(52) U.S. Cl. CPC A24F 40/46; A24F 40/10; A24F 40/44; H05B 3/44; A24F 40/485; A24F 40/57; A24F 1/30

(57) ABSTRACT

A vaporization element, device and method for vaporizing phyto material. A hollow member defining a fluid pathway is positioned proximate a heating element with a phyto material contact surface. An electrical heater is positioned on the opposite side of the phyto material contact surface. Phyto material or extract deposited on the phyto material contact surface can be vaporized by heat from the electrical heater. The vapor can enter the fluid pathway and pass through the hollow member to an inhalation aperture. The electrical heater may be powered by an electrical power source provided in a support unit. The hollow member can be mounted to a vapor processing device that cools and/or filters the vapor before it reaches the inhalation aperture and held in place on a downstem of a water pipe or a vapor processing device.

### CROSS REFERENCE TO RELATED APPLICATION

This application claims the benefit is a Continuation in Part of U.S. application Ser. No. 17/194,214, filed on Mar. 6, 2021 to which priority and benefit is claimed, which claims the benefit of and priority to U.S. Provisional Application No. 62/989,387 filed on Mar. 13, 2020 and U.S. Provisional Application Nos. 62/986,701 filed Mar. 8, 2020, the entireties of which are incorporated herein by reference. This application is a Continuation in Part of U.S. application Ser. No. 16/711,569, filed on Dec. 12, 2019 to which priority and benefit is claimed, which claims the benefit of and priority to U.S. patent application Ser. No. 15/240,203 filed on Aug. 18, 2016, now U.S. Pat. No. 10,537,690, which claims the benefit of and priority to the filing date of U.S. Provisional Application 62/215,168 filed on Sep. 8, 2015, the disclosures of which are incorporated herein by reference.

### FIELD OF THE INVENTION

The technical field relates to a device for vaporization of phyto materials and more specifically to a device for vaporization of phyto material extracts.

### INTRODUCTION

The following is intended to introduce the reader to the detailed description that follows and not to define or limit the claimed subject matter. Aromatherapy generally uses essential oils, which are extracted from phyto materials, such as leaves of plants, for therapeutic benefits. These essential oils are either massaged into the skin or can be inhaled. In some cases the phyto materials are heated in order to released the essential oils therefrom. By heating these phyto materials at predetermined temperatures, essential oils and extracts are boiled off, depending upon the temperature at which these phyto materials are heated, an aroma or vapor is given off, which is then inhaled by a user for its therapeutic benefits. Devices that provide such operation are generally known as vaporizers. There are also extracts available that are derived from the phyto material or loose-leaf aromatherapy materials and these have a consistency of honey and are typically highly purified forms. Normally these extracts are vaporized at temperatures between 500 to 700 degrees Fahrenheit.

Devices that process these concentrated phyto material extracts typically include a waterpipe, or water filtration apparatus, that has an input port and an inhalation aperture with a fluid pathway formed therebetween. Normally a metal or ceramic vaporization element is inserted into the input port and it is heated with a torch to get it to reach a temperature of about 500 to 700 degrees Fahrenheit. Measurement of the temperature of the vaporization element is not measured and usually the process is a visual or time based one. Phyto material extract is applied to the vaporization element and a user inhales from the inhalation aperture of the waterpipe, which results in vaporized phyto material and ambient air to flow into the inhalation aperture and into the fluid pathway for being cooled by the water which is typically disposed within this fluid pathway to cool the vapor air mixture.

Because the heating is performed by a torch, such devices do not typically vaporize the concentrated phyto material extracts and instead combust them. Heating to combustion temperatures usually results in smoke and other combustion by products to be inhaled therefrom. This combustion of course isn't a safe process as there are many harmful byproducts released in the combustion process. Glass or ceramic vaporization elements are preferable as these materials offer an experience that affects a taste of the vapor the least.

There are other solutions on the market that utilize a metal nail with a heater coil wrapped around it that are normally plugged into a wall, however these devices are cumbersome and not power efficient because of an amount of thermal mass that needs to be heated in order to attain a required vaporization temperature of the heated member. They are also not appealing in product design and can lead to end users tripper over the power supply cables. Not to mention that these devices are also not portable.

It is therefore an object of the invention to provide an aromatherapy vaporization device that overcomes the aforementioned deficiencies.

### SUMMARY

The following introduction is provided to introduce the reader to the more detailed description to follow and not to limit or define any claimed or as yet unclaimed invention. One or more inventions may reside in any combination or sub-combination of the elements or process steps disclosed in any part of this document including its claims and figures.

In accordance with the embodiments of the invention there is provided a device for vaporization of concentrated phyto material extracts for attaching to a waterpipe having an input port and an inhalation aperture with a waterpipe fluid pathway formed therebetween comprising: a vaporization element comprising: an elongated hollow member formed from a low thermal conductivity material having a first end and a second end opposite the first end, a fluid pathway propagating through the elongated hollow member from the first end to the second end thereof, the second end for coupling with the waterpipe input port; an annular heating element having a first side and a second side opposite the first side, the annular heating element thermally coupled with the elongated hollow member proximate the first end and having the first side facing the first end with the fluid pathway propagating through a center thereof, the annular heating element comprising a first electrical contact and a second electrical contact proximate the second side, the annular heating element secured to the elongated hollow member for allowing thermal expansion thereof along a radial axis perpendicular to the fluid pathway, the annular heating element comprising a resistive heater disposed between the first and second electrical contacts and proximate the second side; and an electrical power source electrically coupled with the first and second electrical contacts for providing of electrical power to the resistive heater for heating of the resistive heater for imparting thermal energy to the annular heating element, wherein during heating of the resistive heater, a portion of the thermal energy is transferred to the annular heating element first side and another portion, other than the first portion, is transferred to the elongated hollow member proximate the first end, upon the annular heating element second side reaching a predetermined temperature the concentrated phyto material extract is applied to the annular heating element first side and becomes vaporized and upon inhalation from the inhalation aperture this vapor is mixed with ambient air and flows through the fluid pathway from the first end where it loses thermal energy to the elongated hollow member proximate the second end as it propagates through the input port of the waterpipe and through the waterpipe fluid pathway and to the inhalation aperture.

In accordance with the embodiments of the invention there is provided a device for vaporization of concentrated phyto material extracts for attaching to a waterpipe having an input port and an inhalation aperture with a waterpipe fluid pathway formed therebetween comprising: a vaporization element comprising: an elongated hollow member formed from a low thermal conductivity material having a first end and a second end opposite the first end, a fluid pathway propagating through the elongated hollow member from the first end to the second end thereof, the second end for coupling with the waterpipe input port; an annular heating element having a first side and a second side opposite the first side, the annular heating element thermally coupled with the elongated hollow member proximate the first end and having the first side facing the first end with the fluid pathway propagating through a center thereof, the annular heating element comprising a first electrical contact and a second electrical contact proximate the second side, the annular heating element secured to the elongated hollow member using silica and for allowing thermal expansion of the annular heating element along a radial axis perpendicular to the fluid pathway, the annular heating element comprising a metallic planar heater disposed on the second side between the first and second electrical contacts; an electrical power source comprising a plurality of batteries electrically coupled with a first control circuit, which is electrically coupled with the first and second electrical contacts for controllably providing of electrical power to the metallic planar heater for heating of the metallic planar heater for imparting thermal energy to the annular heating element, wherein during heating of the metallic planar heater, a portion of the thermal energy is transferred to the annular heating element first side and another portion, other than the first portion, is transferred to the elongated hollow member proximate the first end, upon the annular heating element second side reaching a predetermined temperature the concentrated phyto material extract is applied to the annular heating element first side and becomes vaporized and upon inhalation from the inhalation aperture this vapor is mixed with ambient air and flows through the fluid pathway from the first end where loses thermal energy to the elongated hollow member proximate the second end as it propagates through the input port of the waterpipe and through to the waterpipe fluid pathway and through the inhalation aperture; and a first housing for having the electrical power source contained there and the plurality of batteries, the first housing comprising an adjustable clamping mechanism for frictionally engaging of the waterpipe.

In accordance with an aspect of this disclosure, there is provided a device for vaporization of concentrated phyto material extracts for attaching to a waterpipe having an input port and an inhalation aperture with a waterpipe fluid pathway formed therebetween comprising: a vaporization element comprising: an elongated hollow member having a first end and a second end opposite the first end, a fluid pathway propagating through the elongated hollow member from the first end to the second end thereof, the second end for coupling with the waterpipe input port; an annular heating element having a first side and a second side opposite the first side, the annular heating element thermally coupled with the elongated hollow member proximate the first end with the fluid pathway propagating through a center of the annular heating element; the annular heating element comprising a first electrical contact and a second electrical contact, the annular heating element secured to the elongated hollow member for allowing thermal expansion thereof along a radial axis perpendicular to the fluid pathway, the annular heating element comprising a resistive heater disposed between the first and second electrical contacts; and a first housing comprising an electrical power source electrically coupled with the first and second electrical contacts for providing of electrical power to the resistive heater for heating of the resistive heater for imparting thermal energy to the annular heating element, them annular heating element comprising a first side for contacting the phyto material extract and a second side fluidly coupled with the fluid pathway, wherein during heating of the resistive heater, thermal energy is transferred to the annular heating element, upon the annular heating element second side reaching a predetermined temperature the concentrated phyto material extract applied to the annular heating element first side and becomes vaporized and upon inhalation from the inhalation aperture this vapor is mixed with ambient air and flows through the fluid pathway from the first end where it loses thermal energy to the elongated hollow member proximate the second end as it propagates through the input port of the waterpipe and through the waterpipe fluid pathway through to the inhalation aperture.

In some embodiments the fluid pathway comprises a vapor path and further comprising: a heating chamber housing having a proximal end and a distal end, an access opening at the proximal end, a vapor outlet at the distal end; wherein the annular heating element comprises a heating element assembly formed from a porous ceramic comprising a proximal end in fluid communication with the access opening proximal the elongated hollow member having first end for receiving of phyto material extract through the access opening and a distal end extending axially from the proximal end 2003p and away from the access opening and proximal the to the second end of the elongated hollow member; a heating chamber formed at the distal end of the heating element assembly and in fluid communication with at least an air intake aperture and a vapor conduit defined from the air intake aperture to the vapor outlet, a vapor path formed from the intake aperture to the vapor conduit to the vapor outlet; wherein the vapor path other than passes through the access opening and the heating element assembly separates the access opening from the heating chamber.

In some embodiments a cavity is formed within the heating element assembly and being defined by an outer sidewall extending from the proximal end to the distal end and an inner sidewall extending from the proximal end and terminating at a cavity floor having a floor thickness and spaced proximally and axially away from the distal end with the cavity being open towards the access opening for receiving of the phyto material extract.

In some embodiments a flange extending radially is provided about the outer sidewall and protruding past the outer sidewall proximate the proximal end and extending distally and having a flange thickness.

In some embodiments the heating element assembly comprises a proximal section and a distal section opposite the proximal section and where a seal member is provided for frictionally engaging the flange and extending at least axially from the flange wherein the flange and seal member are for fluidly sealing of the access opening for receiving of phyto material extract from the heating chamber other than for fluid to propagate through the porous structure of the heating element assembly.

In some embodiments the heating element assembly comprises a porous ceramic structure formed from a unitary construction and the inner sidewall for receiving and contacting the phyto material extract.

In some embodiments the heating element comprises wherein the vapor conduit wherein the outer sidewall is in fluid communication with the vapor conduit.

In some embodiments the heating element assembly comprising a heating element wire disposed between the inner and outer sidewall.

In some embodiments the heating element assembly comprises a proximal annular end with the cavity formed within the center of the annular end and the heating element wire is disposed towards the distal annular end of the heating element assembly.

In some embodiments a releasably engageable power and vapor conduit is provided for receiving of electrical power from an external power source for providing of the electrical power to the heating element wire, wherein the heating element assembly comprises the porous ceramic structure for receiving a material for vaporization and for substantially containing the heating element wire embedded therein and for when the heating element wire is energized upon receiving of electrical energy from the external power source for wicking the material for the inner sidewall towards the heating element wire and heating of the material for vaporization to a predetermined temperature proximal the heating element wire for creating a vapor therefrom for being emitted into the vapor conduit from the outer sidewall and for wicking the material for vaporization from the inner sidewall into the porous ceramic structure.

In some embodiments a distance between the inner and outer sidewall of the heating assembly comprise a wall thickness where the wall thickness is between 0.8 mm and 1.2 mm and wherein a porosity of the porous ceramic is about 30% to 50%.

In accordance with an aspect of this disclosure, there is provided a device for vaporization of concentrated phyto material extracts for attaching to a waterpipe having an input port and an inhalation aperture with a waterpipe fluid pathway formed therebetween comprising: a heating chamber assembly, comprising: a heating chamber housing having a proximal end and a distal end, an access opening at the proximal end, a vapor outlet at the distal end and a releasably engageable power and vapor conduit formed at the distal end with the vapor outlet formed within the releasably engageable power and vapor conduit; a heating element assembly formed from a porous ceramic comprising a proximal end in fluid communication with the access opening for receiving of phyto material extract through the access opening and a distal end extending axially from the proximal end and away from the access opening; a heating chamber formed at the distal end of the heating element assembly and in fluid communication with at least an air intake aperture and a vapor conduit defined from the air intake aperture to the vapor outlet, a vapor path formed from the intake aperture to the vapor conduit to the vapor outlet, wherein the vapor path other than passes through the access opening and the heating element assembly separates the access opening from the heating chamber; a control module comprising: a proximal side, a distal side, and sidewalls extending from the proximal side to the distal side and a battery coupled with a control circuit enclosed between the proximal side and distal side of the control module, a releasably engageable power and vapor conduit receiver formed on the proximal side of the control module for releasably engaging with the releasably engageable power and vapor conduit for controllably providing of electrical power from the control circuit to the heating element assembly, a water pipe adapter coupling port disposed on the distal side of the control module; a control module vapor conduit formed between the releasably engageable power and vapor conduit receiver and the water pipe adapter coupling port; a water pipe adapter comprises a control module receiver disposed at a water pipe adapter proximal end for releasably attaching with the control module water pipe adapter coupling port and having a water pipe adapter distal end for frictionally engaging the water pipe input port comprising a downstem from one of an outside surface of the downstem and an inside surface of the downstem, wherein the downstem comprises a lumen, wherein when the releasably engageable power and vapor conduit receiver is releasably engaged with the releasably engageable power and vapor conduit for fluidly coupling of the vapor conduit to the vapor outlet with the control module vapor conduit and the waterpipe having the input port comprising a lumen and for the control circuit to controllably provide of electrical power to the heating element assembly.

In some embodiments the releasably engageable power and vapor conduit comprises one of a threaded engagement and a magnetic engagement for facilitating the releasable engaging thereof.

In some embodiments upon receiving of electrical energy from the external power source comprises providing a heating profile from the received electrical energy from the external power source for applying of the heating profile to the heating element wire.

In some embodiments the heating profile comprises a PWM profile comprising a plurality of pulse width modulation values applied to the heating element wire over a period of time.

In some embodiments a vapor path gap is radially spaced from the outer sidewall to an inner sidewall of the vapor conduit, the vapor path for propagating through the vapor path gap.

In some embodiments the air intake aperture is formed on a side of the heating chamber housing and the vapor path propagates radially from the air intake aperture towards the outer sidewall and distally along the outer sidewall and between the outer sidewall and the inner sidewall of the vapor conduit and distally towards the distal end of the heating chamber housing.

In accordance with an aspect of this disclosure, there is provided a device for vaporization of concentrated phyto material extracts for attaching to a waterpipe having an input port and an inhalation aperture with a waterpipe fluid pathway formed therebetween comprising: providing a heating chamber assembly having a proximal end and a distal end, a heating element assembly disposed between the proximal and distal ends, a proximal end of the heating element assembly facing and access opening for receiving of phyto material extracts and a distal end of the heating element assembly fluidity coupled with a heating chamber; a vapor path formed from an air intake aperture through the heating chamber and out from a releasably engageable power and vapor conduit having a vapor outlet at the distal end; proximally attaching the heating chamber assembly to a control module through engaging of the releasably engageable power and vapor conduit receiver with the releasably engageable power and vapor conduit; distally attaching a water pipe adapter with a control module receiver through a water pipe adapter coupling port formed on a distal side of the control module; controllably providing of a providing pulse width modulation heating profile from the control circuit to the heating element assembly; coupling of the water pipe adapter coupling port with the waterpipe having the input port; and heating of the heating element assembly to at least a predetermined temperature using the provided pulse width modulation heating profile.

In some embodiments the releasably engageable power and vapor conduit receiver and the access opening and the water pipe adapter coupling port are axially aligned.

In some embodiments the releasably engageable power and vapor conduit receiver and the access opening are axially aligned and are radially offset from the water pipe adapter coupling port.

In some embodiments the battery is radially spaced from the control module vapor conduit.

In some embodiments the battery when viewed from the proximal side of the control module comprises a C shape and the control module vapor conduit is formed within a cut-out of the C shaped battery.

In some embodiments the battery when viewed from the proximal side of the control module comprises a rounded shaped battery and the control module vapor conduit is formed within a cut-out of a side of the rounded shaped battery.

In some embodiments the releasably engageable power and vapor conduit receiver is parallel with the proximal side and the control module vapor conduit is transverse to the proximal side.

In some embodiments the releasably engageable power and vapor conduit receiver and the releasably engageable power and vapor conduit comprises one of a threaded and magnetic coupling.

In some embodiments the control module receiver is for magnetically releasably coupling with the water pipe adapter coupling port.

In some embodiments the control module receiver comprises a second magnet and the water pipe adapter coupling port comprises a first magnet wherein a polarity of the first magnet is different than a polarity of the first magnet and the first and second magnet attract each other.

In some embodiments the first and second magnets are cylindrical magnets and the control module vapor conduit is aligned through a center of the first and second magnets to fluidly connect with the water pipe adapter distal end.

In some embodiments the water pipe adapter comprises a male distal end for releasably frictionally engaging an inside surface of the lumen of the downstem where the vaporizer assembly is supported by the inside surface of the lumen.

In some embodiments the water pipe adapter comprises a female distal end for releasably frictionally engaging an outside surface of the lumen of the downstem where the vaporizer assembly is supported by the outer surface of the lumen.

In some embodiments the control module comprises a user interface electrically coupled with the control circuit for determining of the controllably providing of electrical power from the control circuit to the heating element assembly.

In some embodiments t the releasably engageable power and vapor conduit receiver comprises a ground electrical connection and a signal electrical connection for being releasably coupled with the releasably engageable power and vapor conduit for coupling of the signal and ground electrical connections with the heating element wire.

In some embodiments the releasably engageable power and vapor conduit receiver comprises the ground and the signal and comprises a type electrical connection for being coupled with the control circuit when the releasably engageable power and vapor conduit is coupled with the releasably engageable power and vapor conduit receiver where the control circuit receives the type electrical connection from the heating chamber assembly for altering a heating profile that is applied to the heating element assembly in dependence upon the type electrical connection.

In some embodiments the releasably engageable power and vapor conduit receiver comprises a ground and a signal electrical connection for being coupled with the control circuit where the control circuit is for providing pulse width modulation heating profile to the heating element assembly.

In accordance with the embodiments of the invention there is provided a device for vaporization of concentrated phyto material extracts for attaching to a waterpipe having an input port and an inhalation aperture with a waterpipe fluid pathway formed therebetween comprising: a vaporization element comprising: an elongated hollow member formed from a low thermal conductivity material having a first end and a second end opposite the first end, a fluid pathway propagating through the elongated hollow member from the first end to the second end thereof, the second end for coupling with the waterpipe input port; a partial annular heating element radially disposed about the elongated hollow member, the partial annular heating element having a first side and a second side opposite the first side, the partial annular heating element thermally coupled with the elongated hollow member proximate the first end and having the first side facing the first end with the fluid pathway propagating through a center thereof, the partial annular heating element comprising a first electrical contact and a second electrical contact proximate the second side, the partial annular heating element secured to the elongated hollow member for allowing thermal expansion thereof along a radial axis perpendicular to the fluid pathway, the partial annular heating element comprising a resistive heater disposed between the first and second electrical contacts and proximate the second side; an electrical power source electrically coupled with the first and second electrical contacts for providing of electrical power to the resistive heater for heating of the resistive heater for imparting thermal energy to the partial annular heating element, wherein during heating of the resistive heater, a portion of the thermal energy is transferred to the partial annular heating element first side and another portion, other than the first portion, is transferred to the elongated hollow member proximate the first end, upon the partial annular heating element second side reaching a predetermined temperature the concentrated phyto material extract is applied to the partial annular heating element first side and becomes vaporized and upon inhalation from the inhalation aperture this vapor is mixed with ambient air and flows through the fluid pathway from the first end where loses thermal energy to the elongated hollow member proximate the second end as it propagates through the input port of the waterpipe and through the waterpipe fluid pathway and through to the inhalation aperture.

### BRIEF DESCRIPTION OF THE DRAWINGS

FIG. 1A illustrates a vaporization element in the form of a first vaporization element;

FIG. 1B illustrates a fluid pathway formed in the first vaporization element;

FIG. 1C illustrates a top view of the first vaporization element;

FIG. 1D illustrates a bottom view of an annular heating element as part of the first vaporization element;

FIG. 1E illustrates a perspective view of a vaporization element in the form of a second vaporization element;

FIG. 1F illustrates a cutaway view of a vaporization element in the form of a second vaporization element;

FIG. 1G illustrates a perspective view of a vaporization element in the form of a third vaporization element having a partial annular heating element;

FIG. 1H illustrates a bottom view of a vaporization element in the form of a third vaporization element having a partial annular heating element;

FIG. 1I illustrates a perspective view of a variation of the third vaporization element having a partial annular heating element and a curved fluid pathway;

FIG. 2A illustrates a perspective view of device for vaporization of concentrated phyto material extracts coupled with a waterpipe and in accordance with a first embodiment of the invention;

FIG. 2B illustrates a device for vaporization of concentrated phyto material extracts in accordance with the first embodiment of the invention from a top view;

FIG. 2C illustrates a device for vaporization of concentrated phyto material extracts in accordance with the first embodiment of the invention from an opened front view;

FIG. 2D illustrates a device for vaporization of concentrated phyto material extracts in accordance with the first embodiment of the invention from a side view;

FIG. 3A illustrates a third embodiment of a heating chamber assembly;

FIG. 3B illustrates a fourth embodiment of a heating chamber assembly;

FIG. 3C illustrates a fifth embodiment of a heating chamber assembly;

FIG. 3D illustrates a sixth embodiment of a heating chamber assembly;

FIG. 4A illustrates a bottom cutaway view of a vaporizer assembly;

FIG. 4B illustrates a top cutaway view of a vaporizer assembly;

FIG. 4C illustrates a top view of a vaporizer assembly according to a third vaporizer assembly coupled with a water pipe;

FIG. 4D illustrates a water pipe with a female end input port and with a vaporizer assembly coupled with a magnetic coupling with the input port;

FIG. 4E illustrates a water pipe with a female end input port and with a vaporizer assembly uncoupled from a magnetic coupling;

FIG. 4F illustrates a control module that may include a user interface;

FIG. 4G illustrates a vaporizer assembly with a curved battery;

FIG. 4H illustrates a vaporizer assembly with a cylindrical battery located transverse;

FIG. 4i illustrates a vaporizer assembly with a cylindrical battery located parallel;

FIG. 5A illustrates a prior art vaporizer apparatus and being normally oriented;

FIG. 5B illustrates a prior art vaporizer apparatus and toppling over;

FIG. 5C illustrates a center of gravity being more centrally located with a third embodiment of the control module being used with a water pipe;

FIG. 6A illustrates an example graph generated with the use of a thermal imaging camera being used to measure through non-contact pyrometry of a heating element assembly;

FIG. 6B illustrates an example graph of a PWM profile;

FIG. 7A illustrates a seventh embodiment of a vaporization element a with a filling lid attached thereto; and

FIG. 7B illustrates a seventh embodiment of a vaporization element a with a filling lid not attached thereto.

### DETAILED DESCRIPTION

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising,” and variations thereof mean “including but not limited to,” unless expressly specified otherwise. A listing of items does not imply that any or all of the items are mutually exclusive, unless expressly specified otherwise. The terms “a,” “an,” and “the” mean “one or more,” unless expressly specified otherwise.

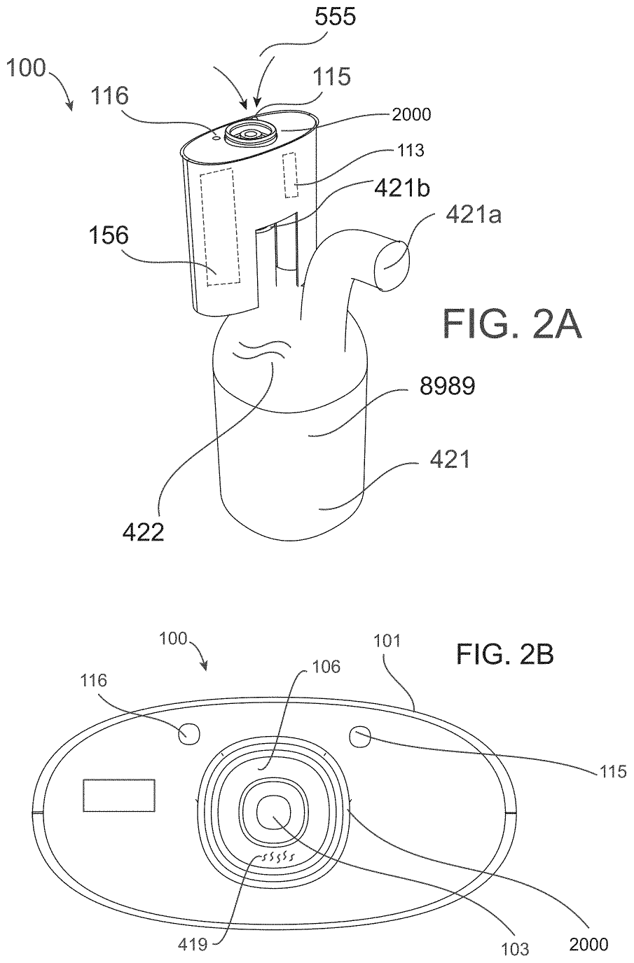

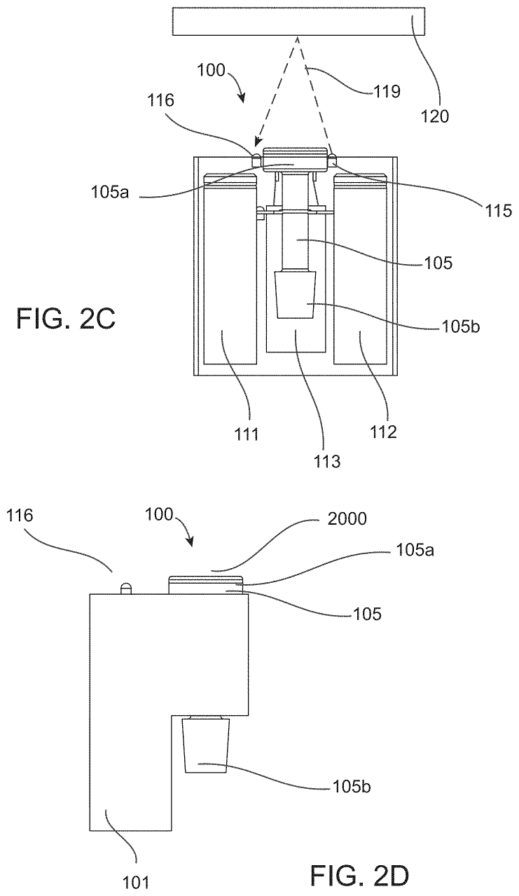

FIG. 2A illustrates a device for vaporization of concentrated phyto material extracts 100 (DVCPM) in accordance with a first embodiment of the invention. The DVCPM 100 is for attaching to a waterpipe 421 having an input port 421b and an inhalation aperture 421a with a waterpipe fluid pathway 8989 formed therebetween.

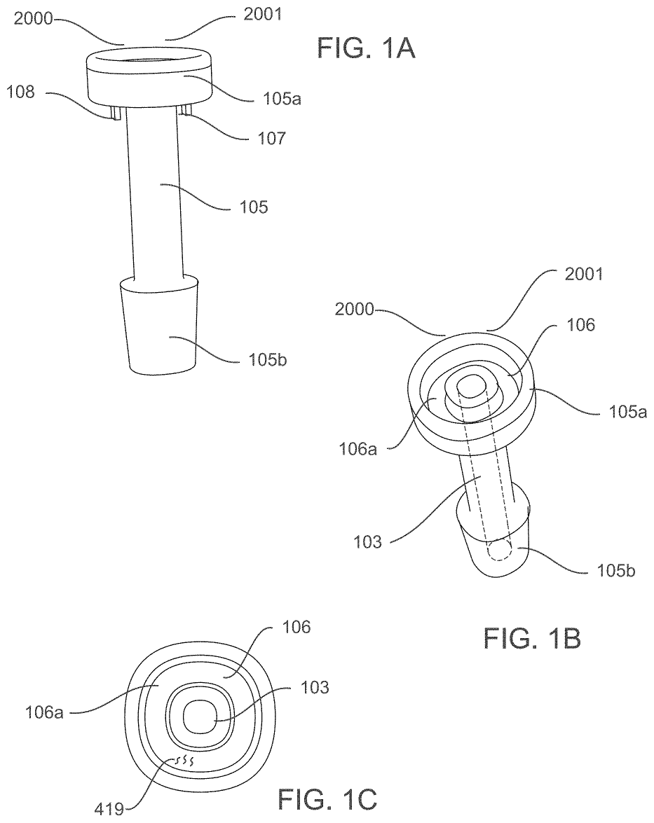

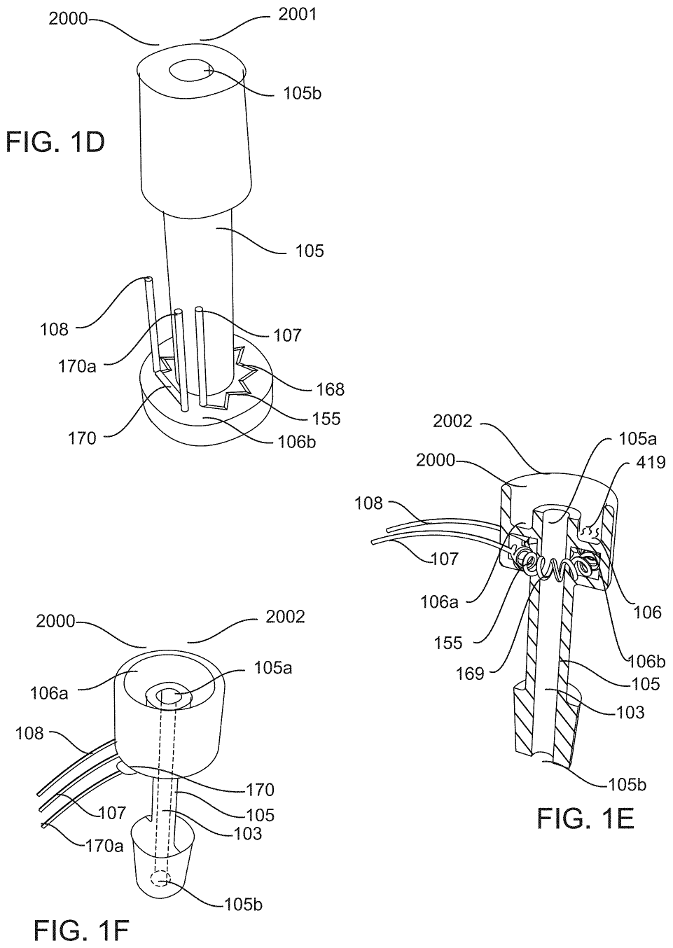

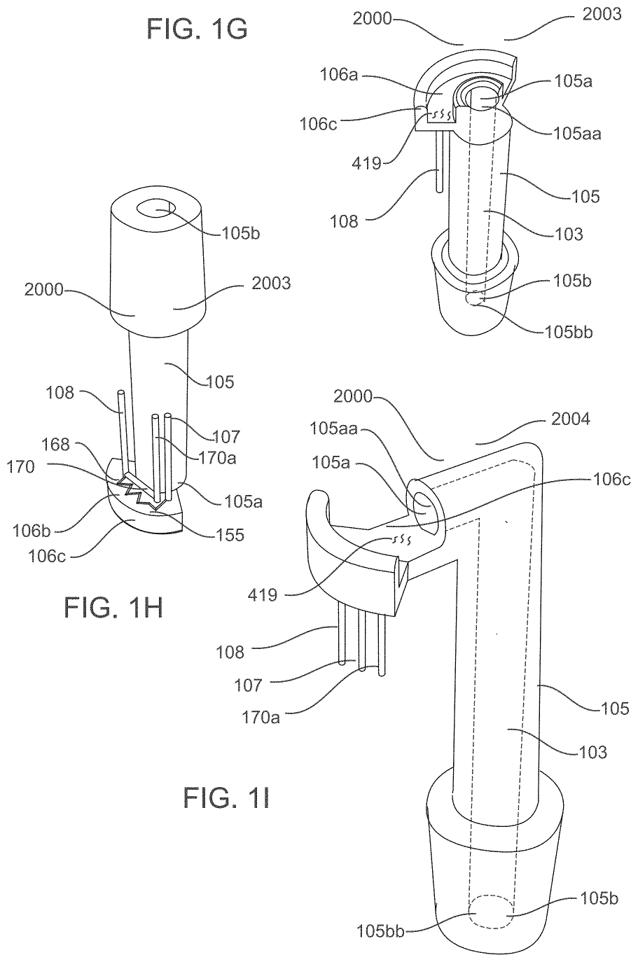

Referring to FIGS. 1A, 1B, 1C, 1D a vaporization element 2000 is shown in the form of a first vaporization element 2001. FIGS. 1E and 1F illustrate a vaporization element 2000 in the form of a second vaporization element 2002 and FIGS. 1G and 1H illustrates a vaporization element 2000 in the form of a third vaporization element 2003. FIG. 11 illustrates a vaporization element 2000 in the form of a fourth vaporization element 2004 that is a variation of the third vaporization element 2003. Throughout the detailed description, the vaporization element 2000 is for use in both of the first and second embodiments of the invention, DVCPM 100 and DVCPM 1000, respectively.

Referring to FIG. 1A, the vaporization element 2000, in the form of a first vaporization element 2001, is shown in perspective view and is formed from an elongated hollow member 105 that is made from a low thermal conductivity material, such as ceramic, and having a first end 105a and a second end 105b opposite the first end 105a, a fluid pathway 103 (as seen in FIG. 1B) propagates through the elongated hollow member 105 from the first end 105a to the second end 105b thereof. The second end 105b is for coupling with the waterpipe input port 421b, as shown in FIG. 2A.

The vaporization element 2000 has an annular heating element 106 having a first side 106a and a second side 106b (FIG. 1D) opposite the first side 106a, the annular heating element 106 is thermally coupled with the elongated hollow member 105 proximate the first end 105a having the first side 106a facing the first end 105a with the fluid pathway 103 propagating through a center thereof (as seen in FIG. 1B), the annular heating element 106 may include a first electrical contact 107 and a second electrical contact 108 proximate the second side 106b. The annular heating element 106 secured to the elongated hollow member 105 for allowing thermal expansion thereof along a radial axis perpendicular to the fluid pathway 103. Without properly securing the annular heating element 106 to the elongated hollow member 105 it is easy to crack the annular heating element 106 due to expansion forces of the elongated hollow member 105 and as such a unitary construction of the annular heating element 106 is preferable.

Referring to FIG. 1D, the annular heating element 106 comprising a resistive heater 155 disposed between the first and second electrical contacts, 107 and 108, and proximate the second side 106b. The annular heating element 106 may include ceramic material where the resistive heater 155 may include a metallic planar heater 168 disposed on the second side 106b between the first and second electrical contacts 107 108 for receiving of electrical energy from the electrical power source 156, wherein the thermal coupling between the annular heating element and the elongated hollow member 105 may include silica material. Silica is also known in the art as ceramic glaze, so the coupling between the annular heating element 106 and the elongated hollow member 105 is by means of a ceramic glaze.

The electrical power source 156 is electrically coupled with the first and second electrical contacts 107 108 for providing of electrical power to the resistive heater 155 for heating of the resistive heater 155 for imparting thermal energy to the annular heating element 106.

As is evident from FIG. 1D, the vaporization element 2000 may include a temperature sensor 170 thermally coupled with at least one of the elongated hollow member 105 and the annular heating element 106 proximate the second side 106b of the annular heating element 106, the temperature sensor 170 has a temperature signal output port 170a for providing a temperature signal in dependence upon the imparting of thermal energy to the annular heating element 106. Typically, the temperature signal is based on a resistance of the temperature sensor 170 and the resistance varies inversely with respect to the temperature being sensed by the temperature sensor 170.

Referring to FIG. 2A, the DVCPM 100 in accordance with the first embodiment of the invention is shown attached to a waterpipe 421 having an inhalation aperture 421a and an input port 421b. The vaporization element 2000, for example the first vaporization element 2001, but it is not limited to the first vaporization element 2001, the second vaporization element 2002 or the third vaporization element 2003 or the fourth vaporization element 2004, any of the vaporization elements 2000 are useable with the DVCPM 100.

In this embodiment the vaporization element 2000 is disposed within the first housing 101 and the first housing 101 frictionally engages the elongated hollow member 105 where the second end 105b of the elongated hollow member 105 couples with the waterpipe input port 421b. An electrical power source 156 (disposed within the first housing 101 and not visible from an outside thereof, but visible in FIG. 2C as the first and second batteries 111, 112) is provided and coupled with a first control circuit 113 electrically coupled with the electrical power source 156 (FIG. 2C) and the first and second electrical contacts 107 108 and the temperature signal output port 170a. The first control circuit 113 for processing of the temperature signal and for controllably providing of the electrical power to the resistive heater 155 for reaching the predetermined temperature of the annular heating element 106 second side 106b.

During heating of the resistive heater 155, a portion of the thermal energy is transferred to the annular heating element 106 first side 106a and another portion, other than the first portion, is transferred to the elongated hollow member 105 proximate the first end 105a, upon the annular heating element 106 second side 106b reaching a predetermined temperature the concentrated phyto material extract 419 is applied to the annular heating element 106 first side 106a (FIG. 1C) and becomes vaporized and upon inhalation from the inhalation aperture 421a this vapor 422 is mixed with ambient air 555 (FIG. 2A) and flows through the fluid pathway 103 from the first end 105a where it receives thermal energy proximate the coupling between the annular heating element 106 and the elongated hollow member 105 and loses thermal energy to the elongated hollow member 105 proximate the second end 105b as it propagates through the input port 421b of the waterpipe 421 and through to the inhalation aperture 421a.

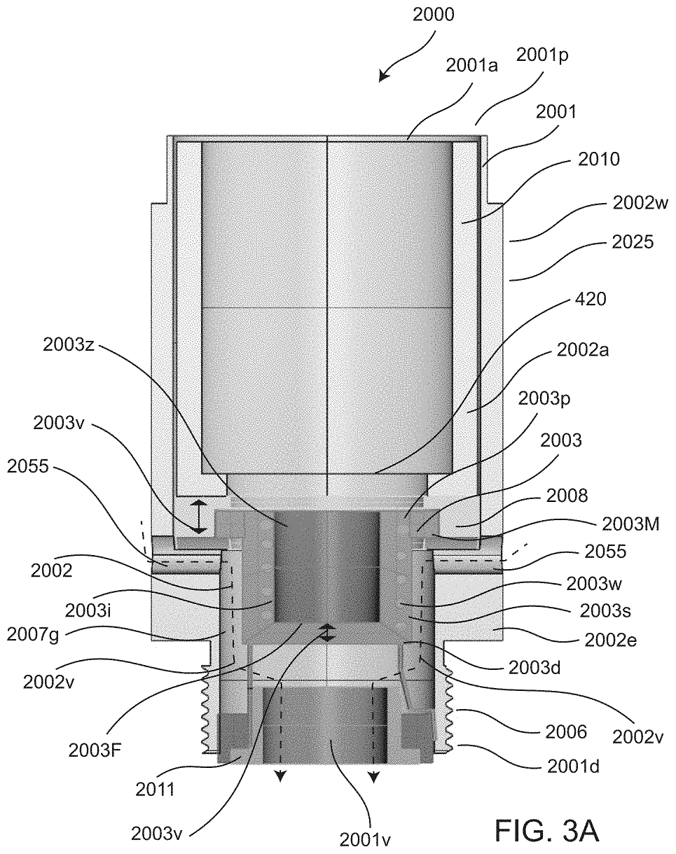

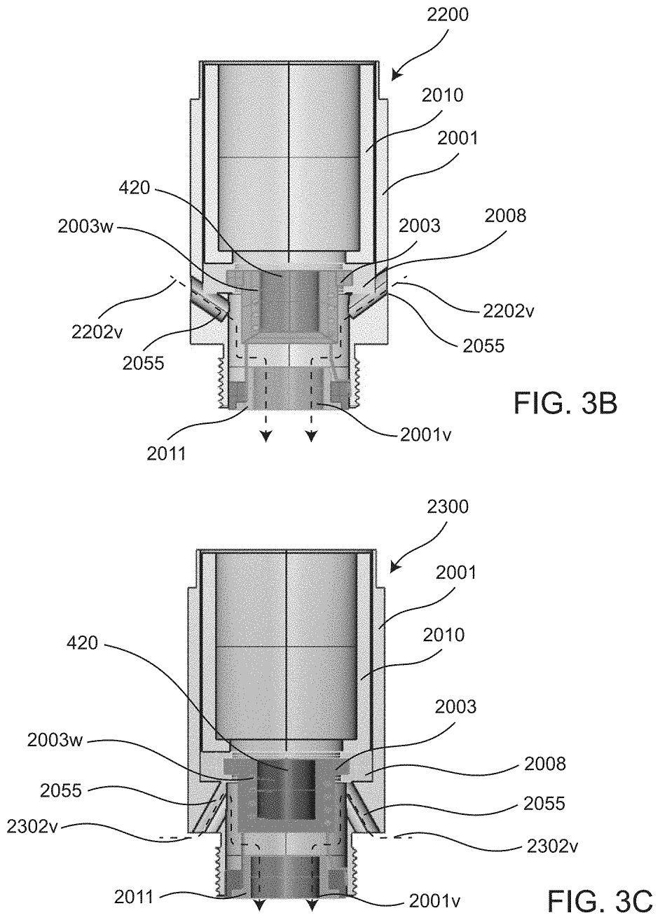

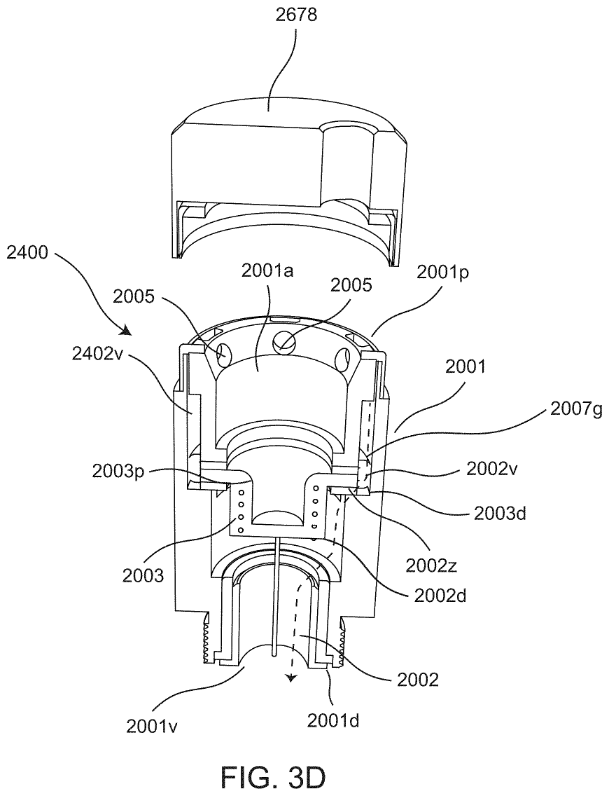

Referring to FIGS. 1E and 1F, the vaporization element 2000, in the form of the second vaporization element 2002, is shown in perspective view and cutaway view, respectively, and is formed from an elongated hollow member 105 that is made from a low thermal conductivity material, such as glass or quartz, and having a first end 105a and a second end 105b opposite the first end 105a, a fluid pathway 103 (as seen in FIG. 1F) propagates through the elongated hollow member 105 from the first end 105a to the second end 105b thereof. The second end 105b is for coupling with the waterpipe input port 421b, as shown in FIGS. 2A and 3A.

The vaporization element 2000 has an annular heating element 106 having a first side 106a and a second side 106b opposite the first side 106a, the annular heating element 106 is thermally coupled with the elongated hollow member 105 proximate the first end 105a having the first side 106a facing the first end 105a with the fluid pathway 103 propagating through a center thereof (as seen in FIG. 1F), the annular heating element 106 comprising a first electrical contact 107 and a second electrical contact 108 proximate the second side 106b, the annular heating element 106 secured to the elongated hollow member 105 for allowing thermal expansion thereof along a radial axis perpendicular to the fluid pathway 103.

Referring to FIG. 1E, a cutaway view of the vaporization element 2000, in the form of the second vaporization element 2002, is shown. The annular heating element 106 comprising a resistive heater 155 disposed between the first and second electrical contacts, 107 and 108, and proximate the second side 106b. The resistive heater 155 may include a resistance wire 169 disposed proximate the second side 106b between the first and second electrical contacts 107 108 for receiving of electrical energy from the electrical power source 156, wherein the thermal coupling between the annular heating element and the elongated hollow member 105 may include glass or quartz.

The electrical power source 156 is electrically coupled with the first and second electrical contacts 107, 108 for providing of electrical power to the resistive heater 155 for heating of the resistive heater 155 for imparting thermal energy to the annular heating element 106.

Referring to FIG. 2A for example, when the second vaporization element 2002 is utilized and during heating of the resistive heater 155, a portion of the thermal energy is transferred to the annular heating element 106 first side 106a and another portion, other than the first portion, is transferred to the elongated hollow member 105 proximate the first end 105a, upon the annular heating element 106 second side 106b reaching the predetermined temperature the concentrated phyto material extract 419 is applied to the annular heating element 106 first side 106a (FIG. 1E) and becomes vaporized and upon inhalation from the inhalation aperture 421a this vapor 422 is mixed with ambient air 555 and flows through the fluid pathway 103 from the first end 105a where it receives thermal energy proximate the coupling between the annular heating element 106 and the elongated hollow member 105 and loses thermal energy to the elongated hollow member 105 proximate the second end 105b as it propagates through the input port 421 b of the waterpipe 421 and through to the inhalation aperture 421a.

Referring to FIG. 1F, the vaporization element 2000 may include a temperature sensor 170 thermally coupled with at least one of the elongated hollow member 105 and the annular heating element 106 proximate the second side 106b of the annular heating element 106, the temperature sensor 170 has a temperature signal output port 170a for providing a temperature signal in dependence upon the imparting of thermal energy to the annular heating element 106. In some cases uses a glass or quartz vaporization element 2000 is preferable because a user can see the resistance wire 169 heating up and it provides a glow as the predetermined temperature is reached.

Referring to FIGS. 1G and 1H, the vaporization element 2000 is shown in the form of the third vaporization element 2003. The vaporization element 2000 in the form of the third vaporization element 2003 is formed from an elongated hollow member 105 that is made from a low thermal conductivity material, such as ceramic, but can also be made from glass or quartz, and having a first end 105a and a second end 105b opposite the first end 105a, the fluid pathway 103 (as seen in FIG. 1G) propagates through the elongated hollow member 105 from the first end 105a to the second end 105b thereof. The second end 105b is for coupling with the waterpipe input port 421b, as shown in FIGS. 2A and 3A.

The vaporization element 2000 has an annular heating element 106 that is a partial annular heating element 106c that does not comprise a full three hundred and sixty degrees arc about the fluid pathway 103 when thermally coupled about the elongated hollow member 105 and has a portion thereof removed, wherein it comprise about a ninety degrees arc about the fluid pathway when disposed about the elongated hollow member 105.

The partial annular heating element 106c is radially disposed with respect to the elongated hollow member 105. As shown in FIG. 1G, the elongated hollow member 105 may include a first aperture 105a a proximate the first end thereof 105a and a second aperture 105bb proximate the second end thereof 105b and the fluid pathway 103 formed between the first and second apertures, 105aa and 105bb, wherein the first and second apertures are axially disposed and may include the resistive heater 155. Preferably the partial annular heating element 106c is disposed proximate the first end 105a of the elongated hollow member 105.

The partial annular heating element 106c has a first side 106a and a second side 106b opposite the first side 106a, partial annular heating element 106c is thermally coupled with the elongated hollow member 105 proximate the first end 105a having the first side 106a facing the first end 105a with the fluid pathway 103 propagating through a center thereof (as seen in FIG. 1G), the partial annular heating element 106c comprising a first electrical contact 107 and a second electrical contact 108 proximate the second side 106b, the partial annular heating element 106c secured to the elongated hollow member 105 for allowing thermal expansion thereof along a radial axis that is perpendicular to the fluid pathway 103.

Referring to FIG. 1H, the partial annular heating element 106c comprising a resistive heater 155 disposed between the first and second electrical contacts, 107 and 108, and proximate the second side 106b. The partial annular heating element 106c may include ceramic material where the resistive heater 155 may include a metallic planar heater 168 disposed on the second side 106b between the first and second electrical contacts 107 108 for receiving of electrical energy from the electrical power source 156, wherein the thermal coupling between the partial annular heating element 106c and the elongated hollow member 105 may include silica material.

The electrical power source 156 is electrically coupled with the first and second electrical contacts 107 108 for providing of electrical power to the resistive heater 155 for heating of the resistive heater 155 for imparting thermal energy to the partial annular heating element 106c.

Referring to FIG. 2A, when the vaporization element 2000 in the form of the third vaporization element 2003 is coupled with the waterpipe 421, during heating of the resistive heater 155, a portion of the thermal energy is transferred to the partial annular heating element 106c first side 106a and another portion, other than the first portion, is transferred to the elongated hollow member 105 proximate the first end 105a, upon the partial annular heating element 106c second side 106b reaching the predetermined temperature the concentrated phyto material extract 419 is applied to the partial annular heating element 106c first side 106a (FIG. 1G) and becomes vaporized and upon inhalation from the inhalation aperture 421a this vapor 422 is mixed with ambient air 555 and flows through the fluid pathway 103 from the first end 105a where it receives thermal energy proximate the coupling between the partial annular heating element 106c and the elongated hollow member 105 and loses thermal energy to the elongated hollow member 105 proximate the second end 105b as it propagates through the input port 421 b of the waterpipe 421 and through to the inhalation aperture 421a.

Referring to FIG. 1H, the vaporization element 2000 may include a temperature sensor 170 thermally coupled with at least one of the elongated hollow member 105 and the partial annular heating element 106c proximate the second side 106b of the partial annular heating element 106c, the temperature sensor 170 has a temperature signal output port 170a for providing a temperature signal in dependence upon the imparting of thermal energy to the partial annular heating element 106c.

FIG. 1I illustrates a variation of the third vaporization element 2003 having the partial annular heating element 2003 in the form of a fourth vaporization element 2004, whereby the resistive heater 155 (not visible in this FIG. 1I) is disposed between the first and second electrical contacts, 107 and 108, is at a distance, for example 20 mm, from an axial center of the first end 105a of the elongated hollow member 105. Whereby in comparison, for the third vaporization element 2003 the resistive heater 155 is approximately 6 mm away from the axial center of the first end 105a of the elongated hollow member 105.

Furthermore, the fluid pathway 103 is curved between the first end 105a and the second end 105b. Such a variation may be preferable so that thermal transfer from the fourth vaporization element 2004 to the elongated hollow member 105 (e.g. a hollow ceramic member) is reduced as well the fourth vaporization element 2004 provides for a lower thermal inertia than the first vaporization element 2001.

The elongated hollow member 105 may include a first aperture 105aa proximate the first end thereof 105a and a second aperture 105bb proximate the second end thereof 105b and the fluid pathway 103 formed between the first and second apertures, wherein the first and second apertures 105aa and 105bb are other than axially disposed and preferably central axes of the first and second apertures 105aa and 105bb are perpendicular to each other.

In this fourth vaporization element 2004 the resistive heater 155 is radially disposed away from the elongated hollow member 105, which therefore results in a bend in the fluid pathway 103. Using the fourth vaporization element 2004 is sometimes preferable as it allows for an elongated path length for the fluid pathway 103 and as such improved cooling for the vapor 422 as it propagates through the fluid pathway 103. If the fourth vaporization element 2004 uses quartz material then the resistive heater 155 is envisaged comprising a pancake ceramic heater or a resistance wire 169. If the fourth vaporization element 2004 uses a ceramic material then the resistive heater 155 is envisaged comprising a metallic planar heater 168 that is sintered onto the ceramic.

Referring to FIG. 2A and in conjunction with FIGS. 2A, 2B and 2D a first infrared transmitter 115 is envisaged for protruding past the first housing 101 proximate the first end 105a of the vaporization element 2000. FIG. 2B illustrates a top view and FIG. 2C illustrates an internal front view and FIG. 2D illustrates a closed side view.

A first infrared receiver 116 is provided for protruding past the first housing 101 proximate the first end 105a of the vaporization element 2000, the first infrared transmitter 115 and the first infrared receiver 116 are electrically coupled with the first control circuit 113, the first infrared transmitter 115 for sending out a first infrared signal 119 for being reflected from an infrared signal reflective member 120 for being received by the first infrared receiver 116 for enabling the heating of the annular heating element 106 (e.g. an annular ceramic heating element) and for other than being received by the first infrared receiver 116 when the infrared signal reflective member 120 is other than present, upon heating of the annular heating element 106, the concentrated phyto material extract 419 is heated to the predetermined temperature and becomes vaporized and this vapor 422 and is mixed with ambient air 555 and flows through the fluid pathway 103, as illustrated in FIG. 2A.

Preferably the infrared signal reflective member 120 is in the form of a hand, whereby when the hand of a user is waived over the top of the DVCPM 100, this activates the first control circuit 113 for heating of the vaporization element 2000. Referring to FIG. 2C, a first battery 111 and a second battery 112 are shown as part of the electrical power source 156. Any of the vaporization elements 2000 in the form of the first through fourth, 2001 through 2004, are envisaged to work with the first infrared transmitter 115 and the first infrared receiver 116.

Having a device for vaporization of concentrated phyto material extracts in accordance with the first and second embodiments of the invention 100 and 1000, respectively, allows for a reduction in potential harm from combustion of the phyto material extracts 419. Furthermore, it allows for a portable device that overcomes the deficiencies in the prior art. Having the vaporization element 2000 manufactured from ceramic or glass or quartz allows for easy cleaning. Also because this vaporization element 2000 is manufactured from a low thermal conductivity material allows for the second end 105b thereof to be substantially cooler than the first end 105a, thus allowing the elongated hollow member 105 to provide additional cooling to the vapors 421 and ambient air 555 when propagating therethrough. Ceramic and glass materials are also easy to clean and do not typically stain when used for vaporization of phyto material extracts 419. The LED 1500 advantageously provides for an indication to the end user of the approximate temperature of the vaporization element 2000. Preferably the electrical power source 156 is from internal battery power, however a wall adapter is also envisaged.

Referring to FIG. 3A, illustrates a third embodiment of a vaporization element, the vaporization element may include a heating chamber assembly 2000 is shown in detail from a cutaway cross section view. The heating chamber assembly 2000 or the vaporization element 2000 includes a heating chamber housing 2001 having a proximal end 2001p and a distal end 2001d, an access opening 2001a at the proximal end 2001p, a vapor outlet 2001v at the distal end 2001d and a heating element assembly 2003 formed from a porous ceramic comprising a proximal end 2003p in fluid communication with the access opening 2001a for receiving of phyto material extract through the access opening 2001a and a distal end 2003d extending axially from the proximal end 2003p and away from the access opening 2001a. There may be a heating chamber 2002 formed at the distal end 2003d of the heating element assembly 2003 and in fluid communication with at least an air intake aperture 2055 and a vapor conduit 2002v defined from the air intake aperture 2055 to the vapor outlet 2001v, a vapor path 2002v formed from the intake aperture 2055 to the vapor conduit 2002v to the vapor outlet 2001v and where the vapor path 2002v does not pass through the access opening 2001a and the heating element assembly 2003 separates the access opening 2001a from the heating chamber 2002. The vapor path 2002v may be external to the access opening 2001a and fluidly coupled with the heating chamber 2002 through the heating element assembly 2003. The vapor path 2002v may pass parallel with the access opening and one of external and internal with the access opening. In some embodiments the vapor path may originate proximate the access opening.

Referring to FIG. 3A, the third embodiment of the vaporization element may be formed from the annular heating element 106 having the first side 106a and the second side 106b (FIG. 1D) opposite the first side 106a, the annular heating element 106 is thermally coupled with the elongated hollow member 105 or the heating chamber housing 2001 proximate the first end 105a having the first side 106a facing the first end 105a with the fluid pathway 103 propagating through a center thereof (as seen in FIG. 1B). The annular heating element or heating element assembly may include a first electrical contact 107 and a second electrical contact 108 proximate the second side 106b. The annular heating element 106 secured to the elongated hollow member 105 for allowing thermal expansion thereof along a radial axis perpendicular to the fluid pathway 103.

The heating chamber assembly 2000 may include a cavity 2003z formed within the heating element assembly 2003 and being defined by an outer sidewall 2003s extending from the proximal end 2003p to the distal end 2003d and an inner sidewall 2003i extending from the proximal end 2003p and terminating at a cavity floor 2003f having a floor thickness 2003u and spaced proximally and axially away from the distal end 2003d with the cavity 2003z being open towards the access opening 2001a for receiving of the phyto material extract (PME). The cavity 2003z may include the first side 106a or the inner sidewall 2003i and the second side 106b, outer sidewall 2003s.

The heating element assembly may also include a flange 2003m extending radially about the outer sidewall 2003s and protruding past the outer sidewall 2003s proximate the proximal end 2003p and extending distally and having a flange thickness 2003n. The flange may be formed from the same material as the heating element assembly 2003 and part of its unitary construction.

The heating element assembly 2003 may include a proximal section 2002q and a distal section 2002e opposite the proximal section 2002q and where the seal member 2008 for frictionally engaging the flange 2003m and extending at least axially from the flange wherein the flange and seal member 2008 are for fluidly sealing of the access opening 2001a for receiving of phyto material extract from the heating chamber 2002 other for other than substantially to allow fluid to propagate through the porous structure of the heating element assembly 2003. Of course, some air and some phyto material extract may percolate and flow through the porous structure from the access opening to the heating chamber. Especially when the heating element is activated then the of phyto material extract 420 may flow within the porous structure as a viscosity of the phyto material extract is reduced with heating of the heating element.

In some embodiments the heating element assembly 2003 may include a porous ceramic structure formed from a unitary construction and the inner sidewall 2003i for receiving and contacting the material for vaporization or the phyto material extract. In some embodiments the heating element assembly outer sidewall 2003s is in fluid communication with the vapor conduit 2002v.

In some embodiments the heating chamber housing 2001 may include a heating element retention member 2010 that is concentrically disposed with the heating chamber housing 2001 and may be inserted from the access opening 2001 a to retain the heating element assembly and the seal member 2008 within the heating chamber housing 2001 and distally pressing the heating element assembly and the seal against a distal portion of the heating chamber housing 2001 such that the distal end of the heating element assembly protrudes into the heating chamber. The heating element retention member may be radially and inwardly spaced from an inside wall of the heating chamber housing 2001 and may frictionally engage with the inside wall of the heating chamber housing 2001.

The heating element assembly 2003 may include a heating element wire 2003w disposed between the inner 2003i and outer sidewall 2003s, where the heating element wire 2003w may be a resistance wire 169 (FIG. 1E). The heating element assembly 2003 may include a proximal annular end with the cavity formed within the center of the annular end and the heating element wire 2003w is disposed towards the distal annular end 2003d of the heating element assembly 2003.

The heating chamber assembly 2000 may include a releasably engageable power and vapor conduit 2006 is for receiving of electrical power from an external power source, such as a battery and control assembly, for providing of the electrical power to the heating element wire 2003w, wherein the heating element assembly may include the porous ceramic structure for receiving a material for vaporization and for substantially containing the heating element wire embedded therein and for when the heating element wire is energized upon receiving of electrical energy from the external power source for wicking the material for the inner sidewall 2003i towards the heating element wire 2003w and heating of the material for vaporization to a predetermined temperature proximal the heating element wire 2003w for creating a vapor therefrom for being emitted into the vapor conduit 2002v from the outer sidewall 2003s and for wicking the material for vaporization from the inner sidewall 2003i into the porous ceramic structure and towards the outer sidewall 2003s.

The heating element wire 2003w may include two heating element wires and one of the wires may couple with the heating chamber housing 2001, for example as a ground terminal and the other may couple with a positive terminal that is insulated from the heating chamber housing 2001 through an insulating member 2011, where in insulating member 2011 may have the vapor conduit 2002v propagating axially through the in insulating member 2011 and the vapor outlet 2001v may be formed at a distal end of the insulating member 2011. The wires may be similar to the first and second electrical contacts 107 108 for receiving of electrical energy from the electrical power source.

In some embodiments a distance between the inner and outer sidewall of the heating assembly 2003 comprise a wall thickness where the wall thickness is between 0.8 mm and 1.2 mm. In some embodiments the floor thickness may be between 0.8 mm and 1.2 mm. In some embodiments a porosity of the porous ceramic is about 40% to 50% and in some embodiments the porous ceramic is about 30% to 40%.

In some embodiments the releasably engageable power and vapor conduit 1006 may include one of a threaded engagement and a magnetic engagement for facilitating the releasable engaging thereof, where electrical power is supplied to the two heating element wires through the one of a threaded engagement and a magnetic engagement.

In some embodiment upon receiving of electrical energy from the external power source may include providing a heating profile from the received electrical energy from the external power source for applying of the heating profile to the heating element wire.

In some embodiment the heating profile may include a PWM profile comprising a plurality of pulse width modulation values applied to the heating element wire over a period of time.

Referring to FIG. 3D, in some embodiment vapor path gap 2007g radially spaced from an inner sidewall 2002z to the outer sidewall 2003s of the vapor conduit 2002v, the vapor path 2002v for propagating through the vapor path gap 2007g.

Referring to FIG. 3B and FIG. 3C, these figures illustrate a heating chamber assembly 2200 and a heating chamber assembly 2300 shown as fourth and fifth embodiment of the heating chamber assembly 2000 where many structural elements are similar to that of the third embodiment 2000 as well as the first and second embodiments. For FIG. 3A, the air intake aperture 2055 is formed on a side of the heating chamber housing 2001 and the vapor path 2002v propagates radially and transversely from the air intake aperture 2055 towards the outer sidewall 2003s and distally along the outer sidewall 2003s and between the outer sidewall 2003s and the inner sidewall 2002z of the vapor conduit 2002v and distally towards the distal end 2001d of the heating chamber housing 2001.

For FIG. 3B, the heating chamber assembly 2200 is shown as the fourth embodiment, the air intake aperture 2055 is formed on a side of the heating chamber housing 2001 and the vapor path 2202v propagates radially and transversely from the air intake aperture 2055, where the vapor path 2202v may originate closer to the proximal end of the heating chamber housing 2001, and towards the outer sidewall 2003s and distally along the outer sidewall 2003s and between the outer sidewall 2003s and the inner sidewall 2002z of the vapor conduit 2202v and distally towards the distal end 2001d of the heating chamber housing 2001 where it may propagate through the insulating member 2011 or past the insulating member 2011.

Referring to FIG. 3C, the heating chamber assembly 2300 shown as the fifth embodiment, the air intake aperture 2055 is formed on a side of the heating chamber housing 2001 and the vapor path 2202v propagates radially and transversely from the air intake aperture 2055, where the vapor path 2302v may originate closer to the distal end of the heating chamber housing 2001 and initially propagate proximally, and towards the outer sidewall 2003s and distally along the outer sidewall 2003s and between the outer sidewall 2003s and the inner sidewall 2002z of the vapor conduit 2302v and distally towards the distal end 2001d of the heating chamber housing 2001 where it may propagate through the insulating member 2011 or past the insulating member 2011. The heating chamber housing 2001 may be a tubular housing and having a circular cross section as the elongated hollow member. The heating element wire 2003w may be a cylindrical resistive heating coil may be at least partially enclosed within the heating element assembly and may be vertically oriented and a portion of the heating element wire 2003w may extend past the outer sidewall 2003s. An enclosed heating element wire 2003w is illustrated in FIG. 1E as part of the vaporization element.

Referring to FIG. 3D, illustrates a sixth embodiment of a vaporization element 2400 or the heating chamber assembly, the vaporization element may include a heating chamber assembly 2000 is shown in detail from a cutaway cross section view. The heating chamber assembly 2000 or the vaporization element 2000 includes a heating chamber housing 2001 having a proximal end 2001p and a distal end 2001d, an access opening 2001a at the proximal end 2001p, a vapor outlet 2001v at the distal end 2001d and a heating element assembly 2003 formed from a porous ceramic comprising a proximal end 2003p in fluid communication with the access opening 2001a for receiving of phyto material extract through the access opening 2001a and a distal end 2003d extending axially from the proximal end 2003p and away from the access opening 2001a.

There may be a heating chamber 2002 formed at the distal end 2003d of the heating element assembly 2003 and in fluid communication with at least an air intake aperture 2055 and a vapor conduit 2002v defined from the air intake aperture 2055 to the vapor outlet 2001v, a vapor path 2002v formed from the intake aperture 2055 to the vapor conduit 2002v to the vapor outlet 2001v. The vapor path 2002v may originate proximate the access opening 2001a with the heating element assembly 2003 substantially separating the access opening 2001a from the heating chamber 2002. The vapor path 2002v may be external to the access opening 2001a and fluidly coupled with the heating chamber 2002 through the heating element assembly 2003. A removable lid 2678 may be provided for being releasably coupled with the access opening 2001a for restricting airflow of ambient air into the air intake aperture 2055 and further into the vapor conduit 2002v.

In some embodiments the vapor conduit 2002v may be formed as a gap between a diameter of the cavity inner sidewall 2003i may be about 4 mm and a diameter of the cavity outer sidewall 2003s may be about 7 mm and a diameter of the heating chamber inner sidewall 1002y may be about 9 mm. An axial height of the heating element assembly 2003 when measured between the distal end 2003d to the proximal end 2003p may be about 5.5 mm. In using such dimensions for the heating element assembly as aforementioned, an area of the heating surface for the phyto material extract 420 formed along the outer sidewall may be about 90 mm\hat{ }2 and if this were in the form of a planar heating surface if may be about 50 mm\hat{ }2. The outer sidewall facilitates vapor production as compared with the planar heating surface.

In some embodiments the heating element assembly according to embodiments of the invention may be manufactured from a porous ceramic structure for receiving a material for vaporization or phyto material extract 420 and for substantially containing the heating element wire 2003w embedded therein and for when the heating element wire 2003w is energized upon receiving of electrical energy from a power source for wicking the phyto material extract 420 from the proximal wicking end 2003p and inner sidewall towards the heating element wire 2003w and heating of phyto material extract 420 to a predetermined temperature (i.e. 500 to 700 degrees Fahrenheit) through a heating profile and for creating a phyto material extract vapor 420v therefrom for being emitted into the vapor conduit 2002v and within the heating chamber.

In certain examples, the phyto material extract 420 may have a viscosity about 15,000 Centipoise. In other embodiments, the vaporizable material may exhibit a viscosity between about 1000 and 5000 Centipoise. For example, a porous ceramic material used with heating element assembly 2003 may have a 40-50% open porosity and with a tortuous pore structure and use pore sizes ranging from 1 to 100 microns, where more specifically it may have pore sizes of 10, 15, 30, 50, 60 and 100 microns. In some embodiments a higher porosity heating element assembly may be used with a higher viscosity material for vaporization and a lower open porosity with lower viscosity phyto material extract 420.

The heating element assembly 2003 may be heated by the heating wire 2003w, a viscosity of the phyto material extract 420 that is applied to the wicking end 2003p may decrease and it may facilitate wicking of the phyto material extract 420 into the heating element assembly 2003 manufactured form the porous ceramic. The phyto material extract 420 may flow from the inner sidewall 2003i towards the outer sidewall 2003s.

The heating wire 2003w may transfer thermal energy to an entirety of the heating element assembly 2003 whereby at the cavity inner sidewall 2003i a measured temperature T1 may be less than a measured temperature T2 at the outer sidewall 2003s.

The phyto material extract 420 may flow towards the outer sidewall 2003s after the heating element wire 2003w being energized upon receiving of electrical energy from a control circuit 2107 (FIG. 2A) and the phyto material extract 420 may pool proximate the cavity floor as pooled phyto material extract 420p. This pooled phyto material extract 420p may travel through the inner 2003i towards the outer sidewall 2003s or percolate through the porous heating element assembly substantially through the porous from the inner 2003i towards the outer sidewall 2003s.

A vaporization surface or heating surface for the phyto material extract 420 may be formed along the outer sidewall 2003s between the heating element assembly distal end and extends axially from the distal to proximal ends and may be spaced radially from a center of the cavity. The inner sidewall 2003i may not be the vaporization surface as the temperature of this surface T1 is less than the predetermined temperature for the vaporization of the phyto material extract 420. The measured temperature T2 at the outer sidewall 2003s may be higher than T1, where T1 may facilitate percolating of the phyto material extract 420 through the porous ceramic heating element assembly and T2. Having the heating surface for the phyto material extract 420 may be formed along the cavity outer sidewall 2003s increases a surface area of the heating surface than if the heating surface were planar as is discussed in some of the prior art. The cavity outer sidewall 2003s is exposed to the heating chamber and the vapor path and hence mat attain the temperature T2 that is larger than T1 where T1 temperature is less than a vaporization temperature of the phyto material extract 420 and T2 is at or above the vaporization temperature of the phyto material extract 420. The phyto material extract 420 proximate the inner sidewall 2003i serves to cool the inner sidewall 2003i from increasing its temperature and having the heating element wire disposed towards the outer sidewall 2003s may facilitate heating of the outer sidewall 2003s over the inner sidewall and result in vapor to flow from the outer sidewall 2003s into the heating chamber.

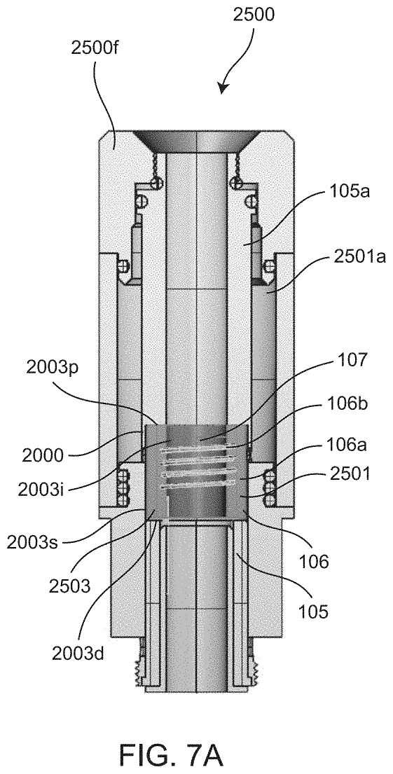

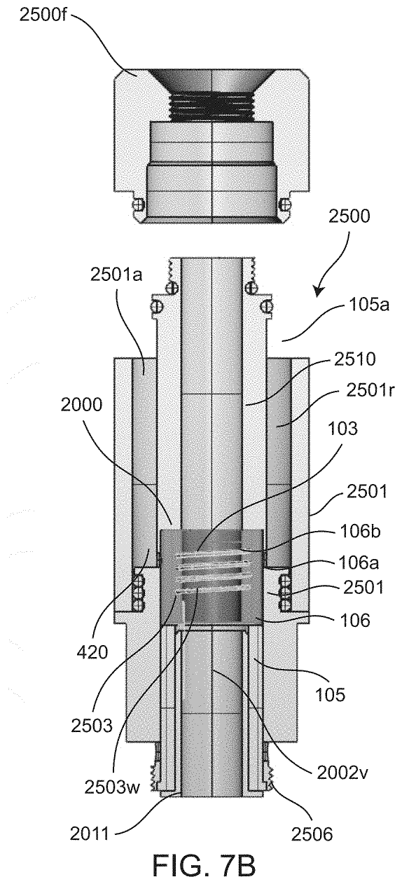

Referring to FIGS. 7A and 7B, a seventh embodiment of a vaporization element 2500 is shown. FIG. 7A illustrates the seventh embodiment of a vaporization element 2500 with a filling lid 2500f attached thereto and FIG. 7B illustrates the vaporization element 2500 with the filling lid 2500f removed therefrom. The seventh embodiment of a vaporization element 2500 includes the annular heating element 106 having the first side 106a and the second side 106b (FIG. 1D) opposite the first side 106a, the annular heating element 106 may be thermally coupled with the elongated hollow member 105 or a heating chamber housing 2501 having the first side 106a fluidly exposed to the first end 105a with the fluid pathway 103 propagating through a center thereof (as seen in FIG. 1B). The annular heating element or heating element assembly may include a first electrical contact 107 and a second electrical contact 108 proximate the second side 106b. The annular heating element 106 secured to the elongated hollow member 105 for allowing thermal expansion thereof along a radial axis perpendicular to the fluid pathway 103. The heating chamber assembly 2000 may include a heating element assembly 2503 and being defined by an outer sidewall 2003s extending from the proximal end 2003p to the distal end 2003d and the inner sidewall 2003i extending from the proximal end 2003p and spaced proximally and axially away from the distal end 2003d. The elongated hollow member 105 may propagate from the proximal end to the distal end.

An access opening 2501a may be provided for receiving of phyto material extract into a reservoir 2501r and further into the heating chamber 2002 other for other than substantially to allow fluid to propagate through the porous structure of the heating element assembly 2003. Of course, some air and some phyto material extract may percolate and flow through the porous structure from the access opening to the heating chamber. Especially when the heating element is activated, the of phyto material extract 420 may flow within the porous structure as a viscosity of the phyto material extract is reduced. The filling lid 2500f may enclose the access opening 2501a so that phyto material extract 420 may be contained within the reservoir 2501r formed between the elongated hollow member 105 and the heating chamber housing 2501, the distal end of the reservoir 2501r being fluidly coupled with the annular heating element 106 first side 106a and capped by the filling lid 2500f. The elongated hollow member 105 propagating through the heating chamber housing 2501 from the proximal end to the distal end thereof. The heating element assembly 2003 may include a porous ceramic structure formed from a unitary construction and the outer sidewall for receiving and contacting the material for vaporization or the phyto material extract 420 and heating element assembly inner sidewall 2003i in fluid communication with the vapor conduit 2002v. A storage compartment or reservoir may be used to store the vaporizable material 420 and the storage compartment may be enclosed by the heating chamber housing 2501. In the example shown, the storage compartment may be parallel to the fluid pathway 103. That is, the fluid pathway 103 and elongated hollow member may define a passage that extends parallel to the storage compartment or reservoir 2501r and the fluid pathway 103 may be fluidly and thermally coupled to the heating element assembly 2003. The storage compartment and the the fluid pathway 103 may be concentrically disposed about a central axis of the the fluid pathway 103.

In some embodiments the heating chamber housing 2501 may include a heating element retention member 2510 that is concentrically disposed with the heating chamber housing 2501 and may be inserted from the proximal end to retain the heating element assembly within the heating chamber housing 2501 and distally pressing the heating element assembly and against a distal portion of the heating chamber housing 2501 such that the heating element assembly protrudes into the heating chamber. The heating element retention member may be radially and inwardly spaced from an inside wall of the heating chamber housing 2501 and may frictionally engage with the inside wall of the heating chamber housing 2501.

The heating element assembly 2503 may include a heating element wire 2503w disposed between the inner 2003i and outer sidewall 2003s, where the heating element wire 2503w may be a resistance wire 169 (FIG. 1E). The heating chamber assembly 2500 may include a releasably engageable power and vapor conduit 2506 is for receiving of electrical power from an external power source, such as a battery and control assembly, for providing of the electrical power to the heating element wire 2503w, wherein the heating element assembly may include the porous ceramic structure for receiving a material for vaporization and for substantially containing the heating element wire embedded therein and for when the heating element wire is energized upon receiving of electrical energy from the external power source for wicking the material for the outer sidewall 2003s towards the heating element wire 2503w and heating of the material for vaporization 420 to a predetermined temperature proximal the heating element wire 2503w for creating a vapor therefrom for being emitted into the vapor conduit 2002v from heating element assembly inner sidewall 2003i and for wicking the material for vaporization from the outer sidewall 2003s into the porous ceramic structure and towards the inner sidewall 2003i.

The heating element wire 2503w may include two heating element wires and one of the wires may couple with the heating chamber housing 2501, for example as a ground terminal and the other may couple with a positive terminal that is insulated from the heating chamber housing 2501 through an insulating member 2011, where in insulating member 2011 may have the vapor conduit 2002v propagating axially through the in insulating member 2011 and the vapor outlet 2001v may be formed at a distal end of the insulating member 2011. The wires may be similar to the first and second electrical contacts 107 108 for receiving of electrical energy from the electrical power source.

In some embodiments, the heater wire 2003w is a wire coil that is other than close wound and with a resistance of about 0.8 Ohms to 1.8 Ohms and may contain an iron-chromium-aluminum (FeCrAl) composition and having an inner diameter that is greater than the cavity inner sidewall 2003i may have an outer diameter that is smaller than the diameter of the cavity outer sidewall 2003s. Of course, other resistive heating wires may be used as are known to those of skill in the art. Wires coupling to the heating element assembly may extend from the distal end 2003d towards the heating chamber floor and spaced radially and axially extending from the heating element assembly.

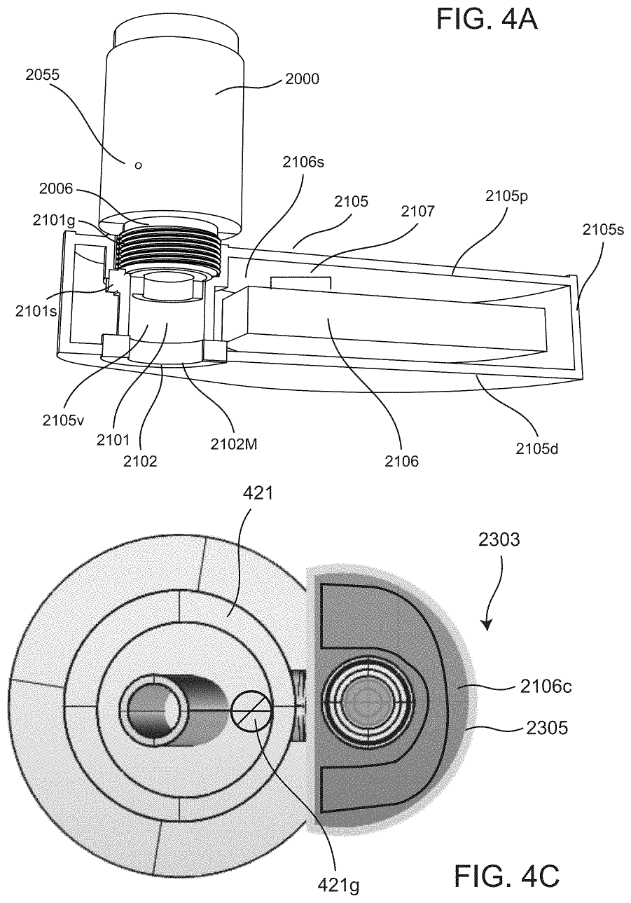

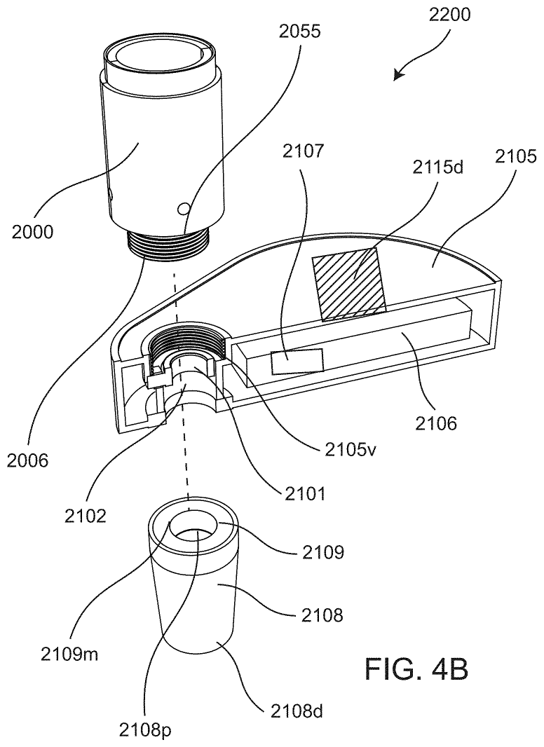

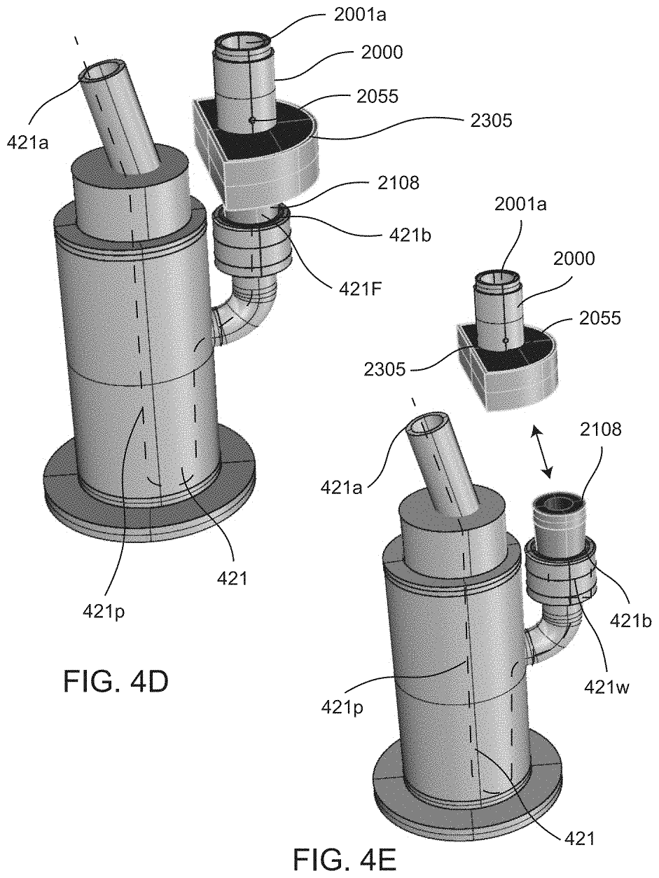

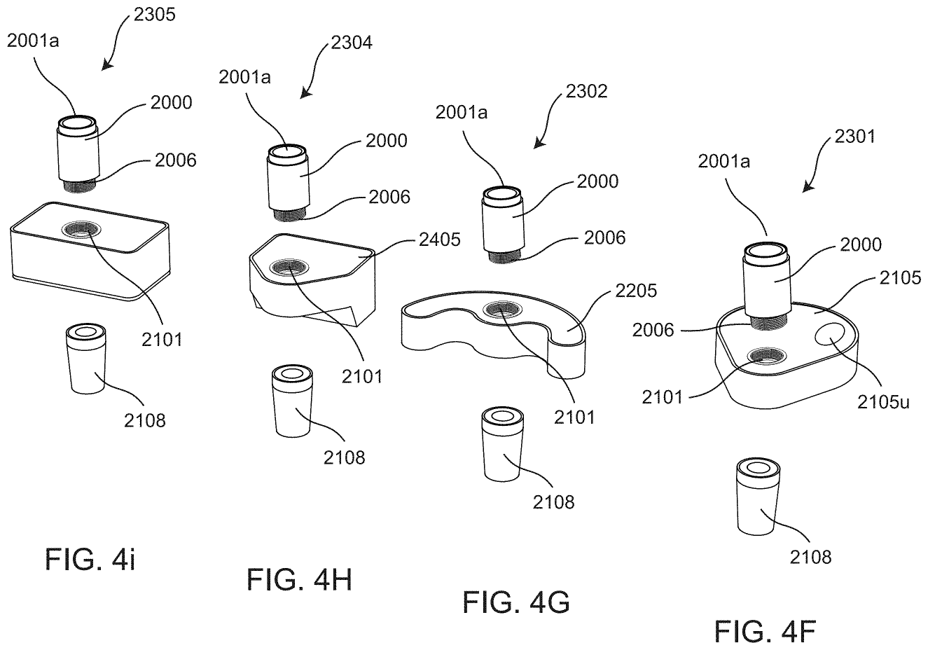

FIG. 4A and FIG. 4B illustrates a cutaway view of a vaporizer assembly, 2200 and 2300 in accordance with embodiments of the invention, where FIG. 4A illustrates a bottom cutaway view and FIG. 4B illustrates a top cutaway view. Referring to FIG. 4A and to FIG. 4B, the first vaporizer assembly 2301 is formed from a heating chamber assembly 2000, such as those described in the embodiment of the invention, where the heating chamber assembly may be the heating chamber assemblies 2200, 2300, 2400. There may be the heating chamber housing 2001 having the proximal end 2001p and the distal end 2001d and having the access opening 2001a at the proximal end 2001p. A vapor outlet 2001v at the distal end 2001d and the releasably engageable power and vapor conduit 2006 formed at the distal end 2001d with the vapor outlet 2001v formed within the releasably engageable power and vapor conduit 2006 and the heating element assembly 2003 formed from a porous ceramic comprising the proximal end 2003p in fluid communication with the access opening 2001a for receiving of phyto material extract through the access opening 2001a and the distal end 2003d extending axially from the proximal end 2003p and away from the access opening 2001a and the heating chamber 2002 formed at the distal end 2003d 1 of the heating element assembly 2003 and in fluid communication with at least the air intake aperture 2055 and a vapor conduit 2002v defined from the air intake aperture 2055 to the vapor outlet 2001v, the vapor path 2002v formed from the intake aperture 2055 to the vapor conduit 2002v to the vapor outlet 2001. In some embodiments the vapor path 2002v may not propagate through the access opening 2001a and the heating element assembly 2003 separates the access opening 2001a from the heating chamber 2002. In some embodiments the vapor path 2002v may originate proximate the access opening 2001a.

A control module 2105 is provided having a proximal side 2105p and a distal side 2105d, and sidewalls 2105s extending from the proximal side 2105p to the distal side 2105p. A battery 2106 may be provided and coupled with the control circuit 2107 enclosed between the proximal side 2105p and distal side 2105d of the control module 2105 and a releasably engageable power and vapor conduit receiver 2101 formed on the proximal side 2105p of the control module 2105 for releasably engaging with the releasably engageable power and vapor conduit 2006 for controllably providing of electrical power from the control circuit 1107 to the heating element assembly 2003 and a water pipe adapter coupling port 2102 disposed on the distal side 2105d of the control module 2105 and a control module vapor conduit 2105v formed between the releasably engageable power and vapor conduit receiver 2101 and the water pipe adapter coupling port 2102 and a water pipe adapter 2108. A control module receiver 2109 may be disposed at a water pipe adapter proximal end 2108p for releasably attaching with the control module 2105 water pipe adapter coupling port 2102 and having a water pipe adapter distal end 2108d for frictionally engaging a water pipe having a downstem from one of an outside surface of the downstem and an inside surface of the downstem, wherein the downstem may include a lumen and wherein when the releasably engageable power and vapor conduit receiver 2101 is releasably engaged with the releasably engageable power and vapor conduit 2006 for fluidly coupling of the vapor conduit 2002v to the vapor outlet 2001v with the control module vapor conduit 2105v and the lumen of the waterpipe and for the control circuit to controllably provide of electrical power to the heating element assembly. The control module may include a display screen 2115d, which may be coupled with the control circuit 2107 (FIG. 4B).

FIG. 4C illustrates a top view of a vaporizer assembly according to a third vaporizer assembly 2303 embodiment of the invention and coupled with a water pipe 421 with a control module 2305 as a third control module 2305. FIG. 2D illustrates a perspective view of a vaporizer assembly according to the third 2303 embodiment of the invention and coupled with a water pipe 421.

FIG. 4E illustrates a perspective view of a vaporizer assembly according to the third vaporizer assembly 2303 embodiment of the invention and coupled with a water pipe 421 with a control module 2105 uncoupled from a water pipe adapter 2108.

FIG. 4F illustrates a perspective view of a vaporizer assembly according to the first vaporizer assembly 2301 embodiment of the invention and with a control module 2105 uncoupled from a water pipe adapter 2108 and uncoupled from the heating chamber assembly 2000.

FIG. 4G illustrates a perspective view of a vaporizer assembly according to a second vaporizer assembly 2302 embodiment of the invention and with a control module 2205 as a second control module 2205 uncoupled from a water pipe adapter 2108 and uncoupled from the heating chamber assembly 2000.

FIG. 4H illustrates a perspective view of a vaporizer assembly according to a fourth vaporizer assembly 2402 embodiment of the invention and with a control module 2405 as a fourth control module 2405 uncoupled from a water pipe adapter 2108 and uncoupled from the heating chamber assembly 2000.

FIG. 4i illustrates a perspective view of a vaporizer assembly according to a fifth vaporizer assembly 2502 embodiment of the invention and with a control module 2505 as a fifth control module 2505 uncoupled from a water pipe adapter 2108 and uncoupled from the heating chamber assembly 2000.

In some embodiments the releasably engageable power and vapor conduit receiver 2101 and the access opening 2001a and the water pipe adapter coupling port 2102 are axially aligned, such as shown in FIGS. 4G through 4i. In some embodiments the releasably engageable power and vapor conduit receiver 2101 and the access opening 2001a are axially aligned and are radially offset from the water pipe adapter coupling port 2102. The may facilitate an improved center of gravity where the battery 2106c and the heating chamber assembly 2000 may be approximately parallel with the control module oriented transversely with their axes. It would be understood by the reader that any of the first through fifth control modules may be used with the water pipe adapter 2108 and the heating chamber assembly 2000. Some the first through fifth control modules may have certain advantages over others as will be explained hereinbelow.

FIG. 4C and FIG. 4D and FIG. 4E illustrate the vaporizer assembly 2303 in accordance with the embodiment of the invention for being coupled with a downstem or an input port 421b of a water pipe 421 or lumen. A female input port is shown for the water pipe however a male end input port may also be used with the water pipe adapter 2108. In the case of FIG. 4D the water pipe has a female end input port 421b and a lumen formed therein and may be known as a female water pipe 421f and having an inwardly tapered cavity 421ff tapering distally. The water pipe 421 having the input port 421b and an inhalation aperture 421a with a water pipe fluid pathway 421p formed therebetween where water may be disposed within the water pipe 421 for having the water pipe fluid pathway 421p propagate therethrough for cooling and filtration of vapor.

In some embodiments the water pipe adapter may include a tapered cavity tip extending towards the distal end thereof whereby upon coupling of the water pipe adapter 2108 the female water pipe 421f may have its inwardly tapered cavity 421ff tapering distally engage with the water pipe adapter 2108.

As shown in FIG. 4E, the releasable water pipe adapter may be releasably coupled with the control module 2105 for releasably frictionally engaging of the control module 2105 from the water pipe adapter by breaking of the magnetic coupling, this may be useful when the vaporizer assembly may be knocked over and it may allow for the control module 2105 to unengaged with the water pipe adapter to prevent damage to the downstem of the water pipe.

Having the water pipe adapter 2108 may facilitate using various styles of water pipes (whether male or female or 14 mm or 10 mm diameters as are known in the art) and to have these various water pipes work with control module in accordance with the embodiments of the invention.

For the fifth 2505, fourth 2405 and first 2105 embodiments of the control module, the battery 2106 may be radially spaced from the control module vapor conduit 2105v. For the third control module 2305 a battery 2106c may be in the form of a C shaped battery 2106c (FIG. 4C) where when viewed from the proximal side 2105p of the control module 2105 may include a C shape and the control module vapor conduit 2105v is formed within a cut-out of the C shaped battery. This orientation of the battery and using a C shaped battery may facilitated a center of gravity of the vaporizer assembly that is closed with the vapor conduit 2105v. When used with a smaller type of water pipe, for example a water pipe that has a contained fluid volume of about 40 ml to 55 ml or less than 100 ml or about 63 ml or in some cases 51 ml. FIG. 4G may utilize a curved battery which may also resemble a C shape and with the control module vapor conduit 2105v may also reside within this cut-out. For example, for the first control module 2105, when viewed from the proximal side 2105p of the control module 2105 may include a rounded shaped battery and the control module vapor conduit 2105v is formed within a cut-out of a side of the rounded shaped battery.

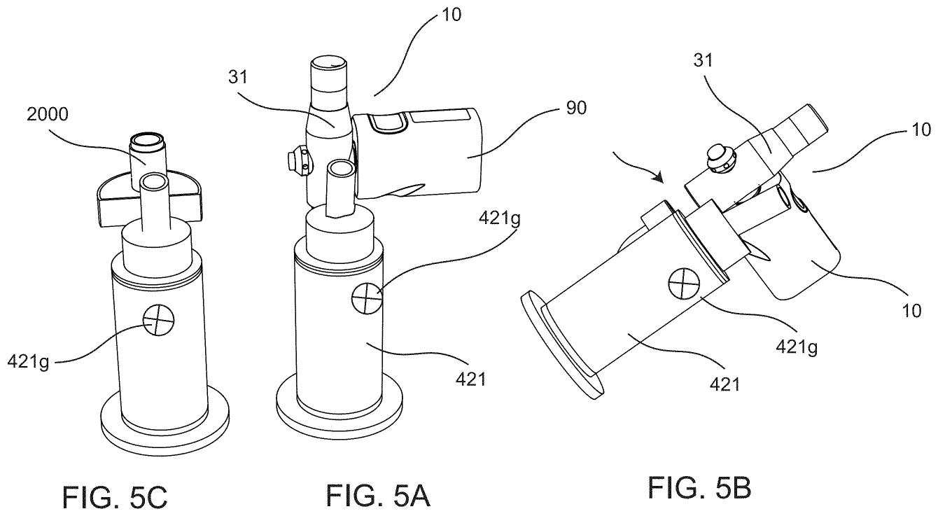

Referring to FIG. 5A and FIG. 5B, a prior art vaporizer apparatus from U.S. Pat. Nos. 10,312,721 and 10,004,264 is shown, where the device 10 includes a power wand 90 that extends from a housing 31 where the device 10 may operate with a typical water pipe as is disclosed by Rado, however in the case of a non-typical water pipe, i.e. one that is smaller in size and more typically used with phyto material extracts, then the water pipe may topple over as shown in FIG. 5B because of a center of gravity 421g being laterally oriented towards one side of the assembly when it is attached with the water pipe downstem. It may therefore be advantageous to have a vaporizer assembly in accordance with the embodiments of the invention that facilitates a closer center of gravity 421g to the downstem. By comparison FIG. 5C and FIG. 4C illustrates the center of gravity being more centrally located with the third embodiment of the control module being used.

In some embodiments the releasably engageable power and vapor conduit receiver 2101 is parallel with the proximal side 2105p and the control module vapor conduit 2105v is transverse to the proximal side 2105p.

In some embodiments the releasably engageable power and vapor conduit receiver 2101 and the releasably engageable power and vapor conduit 2006 may include one of a threaded and magnetic coupling, wherein the threaded coupling is shown in FIGS. 4F to 4i.

In some embodiments the control module receiver 2109 is for magnetically releasably coupling with the water pipe adapter coupling port 2102, such as shown in FIG. 4E. This may facilitate changing of the control module in case the battery contained therein has been depleted.

In some embodiments, such as shown in FIGS. 4A and 4B, the control module receiver 2109 may include a second magnet 2109m and the water pipe adapter coupling port 2102 may include a first magnet 2102m wherein a polarity of the first magnet is different than a polarity of the first magnet and the first and second magnet attract each other. In some embodiments, the first and second magnets are cylindrical magnets and the control module vapor conduit 2105v is aligned through a center of the first and second magnets to fluidly connect with the water pipe adapter distal end 2108d.

In some embodiments, such as shown in FIGS. 4D and 4E, the water pipe adapter 2108 may include a male distal end 2108d for releasably frictionally engaging an inside surface of the lumen of the downstem where the vaporizer assembly is supported by the inside surface of the lumen. In some embodiments, the water pipe adapter 2108 may include a female distal end for releasably frictionally engaging an outside surface of the lumen of the downstem where the vaporizer assembly is supported by the outer surface of the lumen.

In some embodiments, such as shown in FIG. 4F, the control module may include a user interface 2105u electrically coupled with the control circuit for determining of the controllably providing of electrical power from the control circuit to the heating element assembly.

In some embodiments, such as shown in FIG. 4A and FIG. 4B, the releasably engageable power and vapor conduit receiver 2101 may include a ground 2101g electrical connection and a signal electrical connection 2101s for being releasably coupled with the releasably engageable power and vapor conduit 2006 for coupling of the signal and ground electrical connections with the heating element wire 2003w.

In some embodiments, the releasably engageable power and vapor conduit receiver may include the ground and the signal and may include a type electrical connection for being coupled with the control circuit when the releasably engageable power and vapor conduit 2006 is coupled with the releasably engageable power and vapor conduit receiver 2101 where the control circuit receives the type electrical connection from the heating chamber assembly for altering a heating profile that is applied to the heating element assembly in dependence upon the type electrical connection.

In some embodiments, the releasably engageable power and vapor conduit receiver may include a ground and a signal electrical connection for being coupled with the control circuit where the control circuit is for providing pulse width modulation heating profile to the heating element assembly.

The water pipe adapter may also facilitate using the control module with water pipes that do not have the down stem vertically oriented and when the downstem is at an angle (such as that shown in the Prior Art), such as 45 degrees, where the water pipe adapter may be curved to work with such water pipes to be able to maintain the heating element assembly approximately level to facilitate better vaporization of the PME.

The control module may be a flat control module and the battery contained therein may include lithium polymer material, (FIG. 4C, 4F, 4G). In either case the battery may have a capacity of about 400 mAh to 1000 mAh or 900 mAh or 420 mAh. In some embodiments, such as that shown in FIGS. 4H and 4i, the battery may be a lithium ion battery and may be cylindrical in shape and for example in FIG. 4i there may be a plurality of batteries arranged about the control module vapor conduit 2105v to facilitate a center of gravity being close with the control module vapor conduit 2105v. In some embodiment a central axis of the battery may be arranged parallel with the vapor pathway or in some embodiments may be perpendicular to the vapor pathway.

For example, the heating element assembly 2003 may be manufactured using a porous ceramic and the porous ceramic acts as the wicking element. The heating element assembly 2003 may be manufactured using a porous ceramic substrate inlaid with the heating wire 2003w or heating coil where the heating wire 2003w may be at least partially embedded within the ceramic substrate. The heating element assembly 2003 may be manufactured from a unitary construction.

In manufacturing the resistive heating wire 2003w together with the heating element assembly 2003 may be manufactured using a process of hardening molding in-cavity. The resistive heating wire is first prepared (for example coiled). The resistive heating wire 2003w may be uniformly manufactured for providing of rapid and uniform heating throughout its length. The resistive heating wire may include materials such as nickel-chromium alloy, iron-chromium-aluminum alloy, stainless steel, pure nickel, titanium or nickel-iron material. The resistive heating wire have a diameter of about 0.1 mm to 0.6 mm.

In preparation of heating element assembly made of the porous ceramic, a ceramic slurry may be prepared with paraffin wax and a ceramic powder. A weight ratio of paraffin is about 30%-50% and a weight of the ceramic powder is 70%-50%. For manufacturing of the ceramic slurry, the paraffin wax is first made into a molten state molten state and then stirred with the ceramic powder for about 3 hours until the paraffin wax and the ceramic powder are completely mixed uniformly. The ceramic powder includes one or more of silica flour, clay, emery powder, silicon carbide, medical stone powder, mullite powder and cordierite powder. Furthermore, the paraffin wax and ceramic powder slurry may include includes one or more of alumina, potassium oxide, magnesium oxide, ferric oxide, silicon dioxide and calcium peroxide.

The resistive heating 2003w may be placed into the mold and then the molten and stirred ceramic slurry is poured into the mold cavity containing the resistive heating wire 2003w. The ceramic slurry is then injected in the mold cavity that contains the resistive heating wire 2003w and hardened. This hardened molded ceramic slurry forms a green body of the ceramic matrix that includes the resistive heating wire 2003w that is embedded in the green body of the ceramic matrix. The resistive heating wire and green body of the ceramic matrix form a ceramic heating body blank.

For the sintering process, the ceramic heating body blank is taken out from the mold cavity and sintered in an aerobic environment with temperature of between about 200° C.-600° C., which makes the paraffin wax turn into a gas and separate from the ceramic green body at this temperature. This ceramic heating body blank is then further heated under vacuum at about 1100° C. in order to obtain a dry and structurally stable ceramic heating body as the heating element assembly 2003. For example, a porous ceramic material used with heating element assembly 2003 may have a 40-50% open porosity and with a tortuous pore structure and use pore sizes ranging from 1 to 100 microns, where more specifically it may have pore sizes of 10, 15, 30, 50, 60 and 100 microns.

The PWM profile being applied to the heating element assembly 2003 may be a PWM (pulse-width modulation) profiles applied over time to a heating element assembly 2003. The PWM profile may represent a duty cycle that is applied from the control circuit 1107 to the heating element assembly 2003. For example, for a PWM value of 100, the duty cycle is 100% and for a PWM value of 50 the duty cycle is about 50%. Each value from the PWM profile is held for about 100 ms when applied to the heating element assembly 2003. In some embodiments it may be held for 10 ms or 150 ms, however for the purposes of this disclosure 100 ms is adequate for explanation purposes.

For creating of the PWM profile, the PWM profile consists of a plurality of PWM values stored in a PWM array, which may be stored within the control circuit 1107, wherein generating a pulse width modulation value from within the array of pulse width modulations may be performed in a calibration phase of the heating element assembly 2003.

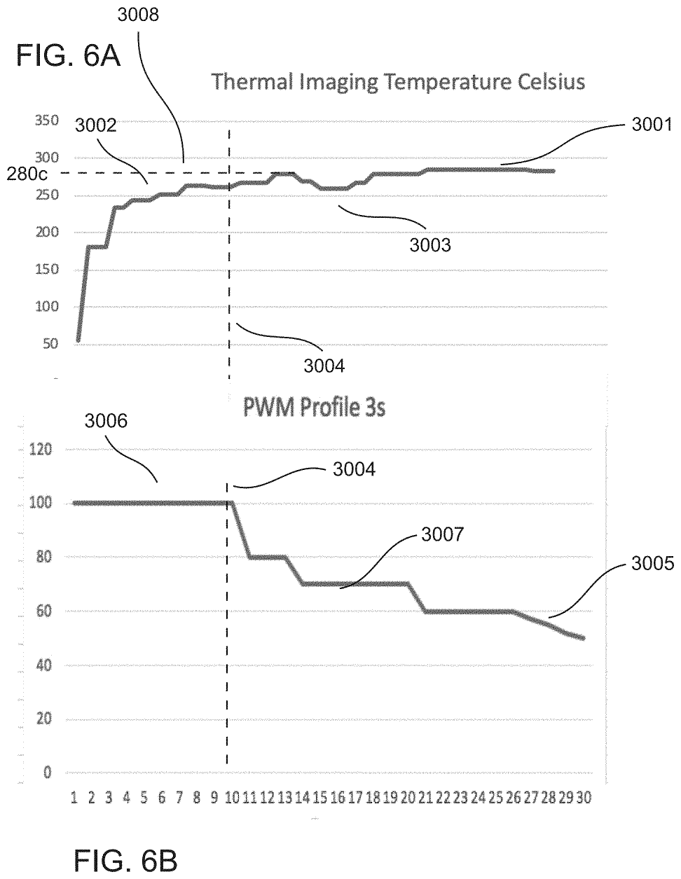

FIG. 6A illustrates an example of a thermal imaging camera being used to measure through non-contact pyrometry of the heating element assembly for observing a temperature signal 3001 that includes the predetermined temperature 3008 of about 280 degrees Celsius. A thermal inertia of the heating element wire and the heating element assembly may affect an applied PWM profile and resulting temperature that is attained by the heating element assembly. This may include a ramp up portion 3002 of the heating element assembly to the plateau portion 3003 and may also include a transition region 3004. Referring to FIG. 3B, an applied PWM profile 3005 to the heating element assembly where this profile may consist of a power application portion 3006 and a power reduction portion 3007. The transition region being between the power application portion 3006 and the power reduction portion 3007. The PWM profile shown in FIG. 6B may have values as follows:

$$PWM\_ 320 Ccoil [ 48 ] = \{ 100 , 100 , 100 , 100 , 100 , 100 , 100 , 100 , 100 , 100 , 80 , 80 , 80 , 70 , 70 , 70 , 70 , 70 , 70 , 70 , 60 , 60 , 60 , 60 , 60 , 60 , 57 , 55 , 52 , 50 , 60 , 60 , 50 , 50 , 60 , 60 , 50 , 50 , 60 , 60 , 60 , 50 , 60 , 60 , 60 , 50 , 60 , 50 \} ;$$

The PWM profile 3005 that may be applied represents a duty cycle that is applied from the control circuit to the heating element assembly. For example, for a PWM value of 100, the duty cycle is 100% (or 0xFF) and for a PWM value of 50 the duty cycle is about 50% (or 0x80). Each value from the PWM profile is held for about 80 ms to 120 ms when applied to the heating element assembly.

Factors affecting the ramp up time may be a thermal inertia and a porosity of the porous ceramic, a type of porous ceramic, and a thickness and resistance of the heating wire and heating element assembly construction. For example, for a resistive wire coil embedded into the heating element assembly, where a plurality of resistive heating wire bands may be in the form of a coiled wire embedded within the porous ceramic heating element assembly may have a resistance of about 1.2 Ohms.

The power application portion 3006 results in the observed temperature of the heating element assembly to rise to the predetermined temperature in about a second and then at the transition region the power reduction portion 3007 of the PWM profile takes place to obtain a substantially flat plateau portion 3003. During the plateau portion 3003 a goal is to maintain a measured temperature of the heating element assembly of about +/−20 degrees Celsius about the predetermined temperature or in some embodiments to a obtain measured temperature of the heating element assembly of about +/−10 degrees Celsius about the predetermined temperature.

In some embodiments a temperature estimation circuit that may be used in conjunction with the heating element assembly where a temperature of a resistive heating element such as a wire or of the heating element assembly, may be estimated by sensing a current being applied to the heating element assembly (atomizer) and for a predetermined voltage being applied to the heating element assembly. Through a temperature coefficient of resistance (TCR) of the heating element assembly, a temperature at which the heating element assembly is operating may be determinable. In other embodiments a temperature sensor may be used.

It will be evident that any of heating chamber assemblies 2000,2200, 2300 may be used with any of the control modules 2105, 2205, 3205, 2405, 2505. Some batteries with vaporizer assemblies in the prior art may hang off to the side of the downstem as a wand and create a large weight that throws off a center of gravity of the on the device which may then sit poorly and on smaller glass pieces the heavy battery as they might cause the water pipe to fall over. Closer to the center of gravity of the water pipe is more optimal.

Having various parts interconnect, (i.e. the heating chamber assembly, the control module and water pipe adapter may facilitate using the vaporizer assembly in accordance with embodiments of the invention with various types of water pipes as well as to easily swap parts should the fail.

Center of gravity of small water pipes that have 10 mm male or female threads will not support a power wand and may fall over as there isn't balance about a downstem thereof so a vertically oriented control module or one that has a center of gravity closer to the downstem may be advantageous.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

What I claim is:

1. A device for vaporization of concentrated phyto material extracts for attaching to a waterpipe having an input port and an inhalation aperture with a waterpipe fluid pathway formed therebetween comprising:
a vaporization element comprising:
an elongated hollow member having a first end and a second end opposite the first end, a fluid pathway propagating through the elongated hollow member from the first end to the second end thereof, the second end for coupling with the waterpipe input port;
an annular heating element having a first side and a second side opposite the first side, the annular heating element thermally coupled with the elongated hollow member proximate the first end with the fluid pathway propagating through a center of the annular heating element;
the annular heating element comprising a first electrical contact and a second electrical contact, the annular heating element secured to the elongated hollow member for allowing thermal expansion thereof along a radial axis perpendicular to the fluid pathway, the annular heating element comprising a resistive heater disposed between the first and second electrical contacts; and
a first housing comprising an electrical power source electrically coupled with the first and second electrical contacts for providing of electrical power to the resistive heater for heating of the resistive heater for imparting thermal energy to the annular heating element, them annular heating element comprising a first side for contacting the phyto material extract and a second side fluidly coupled with the fluid pathway,
wherein during heating of the resistive heater, thermal energy is transferred to the annular heating element, upon the annular heating element second side reaching a predetermined temperature the concentrated phyto material extract applied to the annular heating element first side and becomes vaporized and upon inhalation from the inhalation aperture this vapor is mixed with ambient air and flows through the fluid pathway from the first end where it loses thermal energy to the elongated hollow member proximate the second end as it propagates through the input port of the waterpipe and through the waterpipe fluid pathway through to the inhalation aperture.

2. A device for vaporization of concentrated phyto material extracts according to claim 1 wherein the fluid pathway comprises a vapor path and further comprising:
a heating chamber housing having a proximal end and a distal end, an access opening at the proximal end, a vapor outlet at the distal end;
wherein the annular heating element comprises a heating element assembly formed from a porous ceramic comprising a proximal end in fluid communication with the access opening proximal the elongated hollow member having first end for receiving of phyto material extract through the access opening and a distal end extending axially from the proximal end 2003p and away from the access opening and proximal the to the second end of the elongated hollow member;
a heating chamber formed at the distal end of the heating element assembly and in fluid communication with at least an air intake aperture and a vapor conduit defined from the air intake aperture to the vapor outlet, a vapor path formed from the intake aperture to the vapor conduit to the vapor outlet;
wherein the vapor path other than passes through the access opening and the heating element assembly separates the access opening from the heating chamber.

3. A device for vaporization of concentrated phyto material extracts according to claim 2 comprising:
a cavity formed within the heating element assembly and being defined by an outer sidewall extending from the proximal end to the distal end and an inner sidewall extending from the proximal end and terminating at a cavity floor having a floor thickness and spaced proximally and axially away from the distal end with the cavity being open towards the access opening for receiving of the phyto material extract.

4. A device for vaporization of concentrated phyto material extracts according to claim 3 comprising: a flange extending radially about the outer sidewall and protruding past the outer sidewall proximate the proximal end and extending distally and having a flange thickness.

5. A device for vaporization of concentrated phyto material extracts according to claim 4 wherein the heating element assembly comprises a proximal section and a distal section opposite the proximal section and where a seal member is provided for frictionally engaging the flange and extending at least axially from the flange wherein the flange and seal member are for fluidly sealing of the access opening for receiving of phyto material extract from the heating chamber other than for fluid to propagate through the porous structure of the heating element assembly.

6. A device for vaporization of concentrated phyto material extracts according to claim 2 wherein the heating element assembly comprises a porous ceramic structure formed from a unitary construction and the inner sidewall for receiving and contacting the phyto material extract.

7. A device for vaporization of concentrated phyto material extracts according to claim 2 wherein the heating element comprises wherein the vapor conduit wherein the outer sidewall 2003s is in fluid communication with the vapor conduit.

8. A device for vaporization of concentrated phyto material extracts according to claim 2 wherein the heating element assembly comprising a heating element wire disposed between the inner 2003i and outer sidewall.

9. A device for vaporization of concentrated phyto material extracts according to claim 7 wherein the heating element assembly comprises a proximal annular end with the cavity formed within the center of the annular end and the heating element wire is disposed towards the distal annular end of the heating element assembly.

10. A device for vaporization of concentrated phyto material extracts according to claim 2 comprising a releasably engageable power and vapor conduit is for receiving of electrical power from an external power source for providing of the electrical power to the heating element wire, wherein the heating element assembly comprises the porous ceramic structure for receiving a material for vaporization and for substantially containing the heating element wire embedded therein and for when the heating element wire is energized upon receiving of electrical energy from the external power source for wicking the material for the inner sidewall towards the heating element wire and heating of the material for vaporization to a predetermined temperature proximal the heating element wire for creating a vapor therefrom for being emitted into the vapor conduit from the outer sidewall and for wicking the material for vaporization from the inner sidewall into the porous ceramic structure.

11. A device for vaporization of concentrated phyto material extracts according to claim 10 a distance between the inner and outer sidewall of the heating assembly comprise a wall thickness where the wall thickness is between 0.8 mm and 1.2 mm and wherein a porosity of the porous ceramic is about 30% to 50%.

12. A device for vaporization of concentrated phyto material extracts for attaching to a waterpipe having an input port and an inhalation aperture with a waterpipe fluid pathway formed therebetween comprising:
a heating chamber assembly, comprising:
a heating chamber housing having a proximal end and a distal end, an access opening at the proximal end, a vapor outlet at the distal end and a releasably engageable power and vapor conduit formed at the distal end with the vapor outlet formed within the releasably engageable power and vapor conduit;
a heating element assembly formed from a porous ceramic comprising a proximal end in fluid communication with the access opening for receiving of phyto material extract through the access opening and a distal end extending axially from the proximal end and away from the access opening;
a heating chamber formed at the distal end of the heating element assembly and in fluid communication with at least an air intake aperture and a vapor conduit defined from the air intake aperture to the vapor outlet, a vapor path formed from the intake aperture to the vapor conduit to the vapor outlet, wherein the vapor path other than passes through the access opening and the heating element assembly separates the access opening from the heating chamber;
a control module comprising: a proximal side, a distal side, and sidewalls extending from the proximal side to the distal side and a battery coupled with a control circuit enclosed between the proximal side and distal side of the control module,
a releasably engageable power and vapor conduit receiver formed on the proximal side of the control module for releasably engaging with the releasably engageable power and vapor conduit for controllably providing of electrical power from the control circuit to the heating element assembly,
a water pipe adapter coupling port disposed on the distal side of the control module;
a control module vapor conduit formed between the releasably engageable power and vapor conduit receiver and the water pipe adapter coupling port;
a water pipe adapter comprises a control module receiver disposed at a water pipe adapter proximal end for releasably attaching with the control module water pipe adapter coupling port and having a water pipe adapter distal end for frictionally engaging the water pipe input port comprising a downstem from one of an outside surface of the downstem and an inside surface of the downstem, wherein the downstem comprises a lumen,
wherein when the releasably engageable power and vapor conduit receiver is releasably engaged with the releasably engageable power and vapor conduit for fluidly coupling of the vapor conduit to the vapor outlet with the control module vapor conduit and the waterpipe having the input port comprising a lumen and for the control circuit to controllably provide of electrical power to the heating element assembly.

13. A device for vaporization of concentrated phyto material extracts according to claim 12 wherein the releasably engageable power and vapor conduit comprises one of a threaded engagement and a magnetic engagement for facilitating the releasable engaging thereof.

14. A device for vaporization of concentrated phyto material extracts according to claim 12 wherein upon receiving of electrical energy from the external power source comprises providing a heating profile from the received electrical energy from the external power source for applying of the heating profile to the heating element wire.

15. A device for vaporization of concentrated phyto material extracts according to claim 12 wherein the heating profile comprises a PWM profile comprising a plurality of pulse width modulation values applied to the heating element wire over a period of time.

16. A device for vaporization of concentrated phyto material extracts according to claim 12 comprising a vapor path gap radially spaced from the outer sidewall to an inner sidewall of the vapor conduit, the vapor path for propagating through the vapor path gap.

17. A device for vaporization of concentrated phyto material extracts according to claim 12 wherein the air intake aperture is formed on a side of the heating chamber housing and the vapor path propagates radially from the air intake aperture towards the outer sidewall and distally along the outer sidewall and between the outer sidewall and the inner sidewall of the vapor conduit and distally towards the distal end of the heating chamber housing.

18. A device for vaporization of concentrated phyto material extracts for attaching to a waterpipe having an input port and an inhalation aperture with a waterpipe fluid pathway formed therebetween comprising:
providing a heating chamber assembly having a proximal end and a distal end, a heating element assembly disposed between the proximal and distal ends, a proximal end of the heating element assembly facing and access opening for receiving of phyto material extracts and a distal end of the heating element assembly fluidity coupled with a heating chamber;
a vapor path formed from an air intake aperture through the heating chamber and out from a releasably engageable power and vapor conduit having a vapor outlet at the distal end;
proximally attaching the heating chamber assembly to a control module through engaging of the releasably engageable power and vapor conduit receiver with the releasably engageable power and vapor conduit;
distally attaching a water pipe adapter with a control module receiver through a water pipe adapter coupling port formed on a distal side of the control module;
controllably providing of a providing pulse width modulation heating profile from the control circuit to the heating element assembly;
coupling of the water pipe adapter coupling port with the waterpipe having the input port; and
heating of the heating element assembly to at least a predetermined temperature using the provided pulse width modulation heating profile.

19. A device for vaporization of concentrated phyto material extracts according to claim 18 wherein the releasably engageable power and vapor conduit receiver and the access opening and the water pipe adapter coupling port are axially aligned.

20. A device for vaporization of concentrated phyto material extracts according to claim 18 wherein the releasably engageable power and vapor conduit receiver and the access opening are axially aligned and are radially offset from the water pipe adapter coupling port.
